(19) United States
(12) Patent Application Publication
(10) Pub. No.: US 2004/0122641 A1
(43) Pub. Date: Jun. 24, 2004

(54) System and method for chemical process scale-up and preliminary design and analysis

(75) Inventors: David C. Miller, Terre Haute, IN (US); Phillip H. Smith, Rochester Hills, MI (US)

Correspondence Address: Doreen J. Gridley, ICE MILLER, One American Square, Box 82001, Indianapolis, IN, 46282-0002, US

(73) Assignee: Lab2Plant, Inc. (an Indiana corporation), Terre Haute, IN (US)

(21) Appl. No.: 10/325,897

(22) Filed: Dec. 20, 2002

(51) Int. Cl. G06G 7/48

(52) U.S. Cl. 703/12; 700/268

(57) ABSTRACT

A system and method for chemical process design and process scale-up. In all embodiments, the system includes a mechanism for development of process topology for at least one chemical reaction, with the at least one chemical reaction comprising a recipe. In one embodiment, the system further includes a language handler for entry of the recipe. The language handler accepts textual information in free form for representation of the recipe. Such free form textual entry reflects the actual, or natural, language, used by chemists to describe laboratory processes, and is therefore very efficient and easy to use. In another embodiment, the at least one chemical reaction comprises a recipe for synthesizing at least one chemical product. The system also includes a mechanism whereby the development of the process topology includes the identification of one or more types of equipment necessary to manufacture the at least one chemical product using the recipe. In a variant thereof, the system also includes a mechanism for sizing the identified equipment based on predetermined amount(s) of the at least one chemical product(s) to be manufactured. This system automatically determines the types and sizes of equipment necessary to manufacture the chemical products. The methods of the present invention involve entry of textual information in free form, with such textual information representative of the recipe, and involve development of a process topology from the recipe, including the automatic identification of the equipment necessary to manufacture the chemical product(s) resulting from the recipe, and, in one embodiment, the sizing of the identified equipment to produce predetermined amount(s) of the chemical products.

### FIELD OF THE INVENTION

The present invention relates to process design for chemical processes, and, more particularly, for a system and method for taking chemicals from discovery to production.

### BACKGROUND OF THE INVENTION

Generally, all industries seek ways to improve upon time-to-market. Reduction of such time decreases the costs associated with new product introduction, increases the potential for revenue from the product, and may also result in the product having a competitive advantage if it is the first such product in the market. Further, if the product or the process of making the product is covered by more than one patent, quick introduction of the product to the market allows the patent owner to take full advantage of the rights afforded by patent protection.

The agrochemical, pharmaceutical, and specialty chemicals industries often face significant challenges in bringing new products to market. Generally, only limited physical property data is available for molecules in these industries, because these molecules have often never been synthesized before. The reaction chemistry and separation methodologies have significant uncertainty associated with them. A great deal of experimentation is usually required to discover suitable reaction conditions, separation techniques, and other criteria. Thus, the development of products in those industries relies upon experimental development of reaction pathways, separation methods, and other criteria or factors.

The requirement for experimentation results in complexity in determining whether early process chemistry development methods are suitable for production. In other words, there exists a significant gap in bridging early process chemistry development to engineering design. Process research is the road along which a chemical will travel as it goes from the research laboratory to manufacture. Typically, chemicals are moved along the process research road by process chemists who try to determine whether the new chemicals developed in the research laboratory can be made in a safe, economical, legal, and environmentally responsible manner. If a chemical passes such scrutiny, the development of product(s) from the chemical proceeds to the responsibility of process engineers. Process engineers design the equipment and manufacturing facility required to manufacture the product(s).

The movement of a synthesized chemical from the laboratory to manufacture is, as a result of the foregoing, an inefficient process involving several persons and several decision points. Cooperation and communication between the research chemist, process chemist, and process engineer is required, and, if deficient in any way, will impede or curtail movement of the chemical along the process research road. Also, the division of responsibilities results in the general problem that engineering ramifications of chemistry decisions are not considered early in the process. By delaying such decisions, significant resources may have been utilized before it is determined that the chemical cannot plausibly be manufactured.

One of the difficulties in achieving synergistic development, i.e., the consideration of all factors including engineering considerations, early in process chemistry development is the distinctiveness of the disciplines of the research chemist and either the process chemist or the process engineer. As a result, and as is true with most distinct disciplines, these individuals do not “speak the same language.” Process chemists are concerned with reaction pathways, separation methods, and the like, while process engineers are primarily concerned with environmental and manufacturing parameters and conditions, for example. For this reason, most prior art systems made available for process research are directed toward the process engineer. The use of such systems by research or process chemists is generally not contemplated. Alternately, a system may be developed for use by the research chemist for laboratory purposes only.

Batch Design kit, a software system made available by Hyprotech of Calgary, Alberta, Canada, provides a process chemist with the capability to scope a synthetic pathway prior to any experimental work. This software essentially allows the user to explore multiple feasible reaction pathways to a product, and then narrow the set of pathways for further design consideration. It is, at this level, basically a graphical interface for bookkeeping. To deal with process engineering, this software then jumps ahead to a detailed design mode in which equipment and process connectivity are specified. At this level, all products of a reaction need to be identified and the designer needs to specify the details of the process flow sheet. Another product, Batch Plus by Aspen Technology of Cambridge, Mass., offers similar functionality. The focus of these systems is detailed engineering which is foreign to both research and process chemists.

Because these prior art systems are primarily intended for use by process chemists or process engineers, the interface used for entry of information regarding the chemical processes recipe is awkward in the eyes of the research chemist and even the process chemist. For Batch Design Kit, the interface is discussed in “A Natural Language Approach for the Design of Batch Operating Procedures”, Linninger, A. and Stephanopoulos, G., Informatics 22 (1998), 423-434 (“Linninger et al.”); and “Synthesis and Assessment of Batch Processes for Pollution Prevention”, Linninger, A., Shahin, A., Stephanopoulos, E., Han, C., and Stephanopoulos, G., Pollution Prevention via Process and Product Modifications 90 (1994), 46-58; and “Synthesis of Batch Processing Schemes for the Production of Pharmaceuticals and Specialty Chemicals, “Ali, S., Ph.D. Thesis, Massachusetts Institute of Technology (1999); and the BDK (Hyprotech) user manual. The interface of Linninger et al is developed for use by those involved in process design. While Linninger refers to use of a “natural” language, this natural language is not true natural (free) form and would be more appropriately described as involving the use of “wizards.” These “wizards” are pull-down menus, radio-button selectors, and the like, commonly used in popular graphical user interfaces such as Windows™ offered by Microsoft Corp. Thus, to enter a reaction, the process chemist or process engineer needs to make several “points” and “clicks” to select all of the necessary language to describe the reaction. Such a wizard-based user interface is inefficient and is also counter intuitive for use by a chemist. Therefore, it is desired to provide a user interface for a process design system that is efficient for entry and is familiar to the chemist.

One system was developed at The Ohio State University for critiques of laboratory-scale process chemistry based on an engineering analysis of a process topology. As described in “Process Design Decision Support System for Developing Process Chemistry,” Miller, D. C. and Davis, J. F., Ind. Eng. Chem Res. 2000, 39, 2954-2969 (Miller et al.) and “A Process Design Decision Support System and Integrated Functional Representation Based Engineering Device Library for Guiding and Evaluating Laboratory-Scale Chemical Synthesis”, Miller, D. C., Ph. D. Thesis, The Ohio State University (1998), this system couples experimental chemistry development with interactive, engineering-based evaluation. In this manner, a process chemist can determine very early in development whether manufacture of the chemical is possible and at what cost. The system of Miller et al. provides an estimate of operating, material, and waste disposal costs and also provides analysis by various “critics”. The critics provide economic, environmental, and safety evaluations of the engineering process and chemicals involved.

While the system of Miller et al. is useful in all phases of process development, and is intended for use by a research chemist, the user interface is inefficient requiring a multiplicity of inputs to define the laboratory process to be evaluated. In this manner, the system of Miller et al. has the same shortcomings as the software of Linninger et al. Thus, as previously stated, it is desired to provide a system having a friendly, more efficient user interface for entry of the laboratory process chemistry by a chemist.

The system of Miller et al. presents many useful features. The process chemist is, generally, able to determine the viability and approximate costs of the manufacture of a product based on the laboratory process. However, use by the chemist of this system is still problematic in at least one respect. The system does not specify unit sizes for a particular scale up. The system assumes that the product(s) will be manufactured at plant scales and that it will fit in “standard size” vessels. It makes no provision for predicting the scale up to just (simply) a larger laboratory scale. It is therefore desired to provide a predictive process design system akin to that of Miller et al. and useable by the process chemist that assists in the determination of type and sizes of equipment appropriate for whatever level of scaling is of interest. Of course, it would be beneficial for such a system to also provide many of the other features and benefits of the system of Miller et al., and also not to be limited to use by the research chemist.

### SUMMARY OF THE INVENTION

The present invention comprises a system and method for chemical process scale-up and preliminary design. Specifically, the system and method are for the development of a process topology from at least one chemical reaction. The at least one chemical reaction comprises a recipe that results in the synthesis of at least one chemical product. In one embodiment of the system, the system includes a language handler for entry of the recipe. The language handler accepts textual information (comprising alpha-numeric characters, generally) in free form for representation of the recipe. The language handler may include a lexer for forming at least one word from the individual characters of the textual information, a parser for forming at least one sentence from the at least one words formed by the lexer, an error checking subsystem for identification of textual information not recognizable by the language handler, and a means for stripping superfluous information (such as prepositions, for example) from the textual information. This system allows for entry of the recipe in a manner familiar to chemists, and independent of the process requirements for manufacture of the chemical product(s) to be manufactured with the recipe. In addition, the language handler of the present invention is efficient.

The simplicity and efficiency of the system involving the language handler is illustrated by the simple method used by a user of such a system. The method includes the steps of entering textual information in free form, and interpreting the textual information into one or more of the group consisting of quantity, units, and commands. The method may also involve, for the interpreting step, the substeps of forming at least one word from the individual characters of the textual information, and forming at least one sentence from the at least one words formed. Additionally, the step of interpretation may involve the substep of stripping superfluous information from the textual information. The method, in another embodiment, includes the steps of establishing a database of recognizable characters and/or words, and checking the textual information for compliance with the recognizable characters and/or words. In the event a character and/or word is not recognizable, the user is then alerted of the non-compliance.

In another embodiment of the present invention, the system includes a mechanism for developing process topology for the at least one chemical product including a means for identifying the equipment necessary to manufacture the at least one chemical product. The identification of the equipment is based on the recipe as entered into the system. The system may also include a means for sizing the identified equipment, with such sizing based on predetermined amount(s) of the at least one chemical products to be manufactured. Such sizing may also be affected by basic physical constraints of the manufacturing facility, and thus, the system may also include a means for comparing the size(s) of the identified equipment with a threshold size, and adjusting the size of any equipment that exceeds the threshold size. This system does not require that the user be versed in process engineering equipment, processes, and preferences. Instead, the selection and sizing of equipment is performed based on laboratory processes and a few reasonable criteria, such as maximum vessel size.

The invention also includes a method related to the selection and sizing of the equipment for the process topology. This method includes the steps of entering the recipe, and developing the process topology including the identification of the equipment necessary to manufacture the at least one chemical product. The identification occurs automatically based on the entered recipe. The development step may further include sizing the identified equipment based on predetermined amount(s) of the at least one chemical products to be manufactured. The system may also include the steps of comparing the size(s) of the identified equipment to a threshold size, and adjusting the size(s) of the identified equipment that exceed the threshold size. This method results in automatic development of process topology for a recipe while meeting very basic process requirements.

### BRIEF DESCRIPTION OF THE DRAWINGS

FIG. 1 shows a screen printout of one embodiment of the pathway developer according to the present invention.

FIG. 2 shows a screen printout of one embodiment of the reaction editor according to the present invention.

FIG. 3 shows a screen printout of further detail of the reaction editor of the embodiment of FIG. 2 illustrating the error correction capability associated with the reaction editor.

FIG. 4 shows a screen printout of one embodiment of the partial process topology generated by the present invention.

FIG. 5A and FIG. 5B show screen printouts of production basis sealing options according to one embodiment of the present invention.

FIG. 6A, FIG. 6B, and FIG. 6C show screen shots of one embodiment of the scaling report according to the present invention.

FIG. 7A and FIG. 7B collectively show a block diagram of one embodiment of the system of the present invention.

FIG. 8A and FIG. 8B show a state diagram for generating process topology according to one embodiment of the system of the present invention.

FIG. 9 shows a state diagram for evaluating process topology according to one embodiment of the system of the present invention.

FIG. 10A and FIG. 10B collectively show a flow chart of one embodiment of the steps used to scale the equipment according to the present invention.

### DETAILED DESCRIPTION OF THE INVENTION

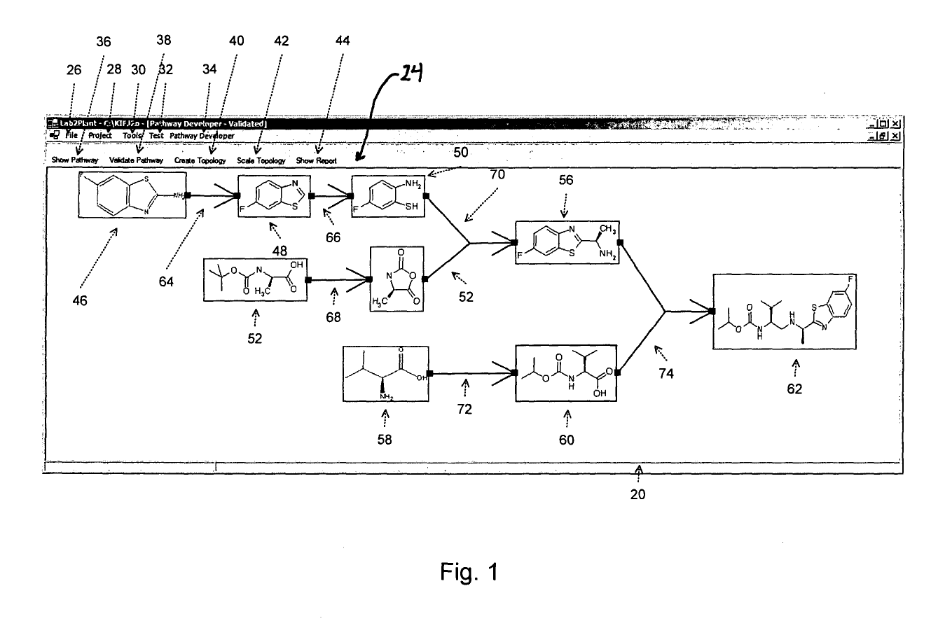

Referring now to FIG. 1, there is shown a screen printout of one embodiment of the pathway developer according to the present invention. In this embodiment, the system of the present invention comprises pathway developer window 20 having main menu 22 and pathway developer menu 24. Pathway developer window 20 is used to develop the pathways for creation of one or more synthesized chemicals from one or more starting chemicals as is performed in the laboratory. As explained in greater detail herein, the pathway developer of the present invention allows a chemist, research chemist, process chemist, process engineer, or other type of user to enter the pathways used in the laboratory for chemical synthesis.

Main menu 22 comprises several submenus as are well known in the art. File submenu 26 contains selections such as ” New”, “Open”, “Close”, “Save”, “Save As”, “Recent Workspaces”, “Preferences”, and “Quit”. Each of these selections has an affect as is well known in the art of graphical user interfaces, such as Windows® by Microsoft Corp. Project submenu 28 contains an alternate method to select items 36, 38, 40, 42 and 44 to show (develop) a pathway, validate a pathway, create a topology, scale a topology, and show a report. In addition, project submenu 28 allows a user to select desired critics and to generate a critic report. Tools submenu 30 contains selections that allow the user to edit substances in the database and view the chemicals available in the database. Test submenu 32 contains selections that are used when implementing new functions in the system. Generally, test submenu 32 is used to test and debug such new functions, and therefore, may not be present in a production or commercial version of the system.

Pathway developer submenu 34 contains selections such as “Add Substance” for adding a substance to the chemical database, “Undo” to undo the last entry, “Redo” to redo an undone entry, “Bind Reaction” for the purpose of binding a selected reaction, “Bind Double Reaction” for the purpose of double binding a selected reaction, “Copy” to copy selected text, “Paste” to past selected text, “Validate Pathway” to invoke a feature of the present invention to make certain that the reaction is valid, and “Enable Editing of Pathway” to be toggled to either permit or disable modification of the pathway.

Pathway developer menu 24, in this embodiment, contains five selections. “Show Pathway” selection 36 allows the user to indicate that the pathway is to be shown on pathway developer window 20. “Validate Pathway” selection 38 allows the user to make certain that the pathway is valid prior to beginning analysis. “Create topology” selection 40 is used to invoke the topology generating capability of the present invention that is described in further detail herein. “Scale Topology” selection 42 allows the user to scale the equipment, and hence the topology, as is described in further detail herein. “Show report” selection 44 allows the user to show (and to print) reports of the generated topology as is described in further detail herein.

In the embodiment of FIG. 1, the user has selected the “Open” selection of file submenu 36 to open a pathway entered into the system in a manner described herein. As a result of such selection, shown in pathway developer window 20 is a graphical representation of the pathway. Within each box 46, 48, 50, 52, 54, 56, 58, 60, and 62 is shown a substance. The reactions conditions for creation of the substances from other substances are illustrated as arrows. In the pathway illustrated in FIG. 1, a first substance shown in first box 46 undergoes first reaction 64 to result in a second substance shown in second box 48. The second substance shown in second box 48 undergoes second reaction 66 to produce a third substance shown in third box 50. In a parallel pathway, a fourth substance shown in fourth box 52 undergoes third reaction 68 to result in a fifth substance shown in fifth box 54. The third substance shown in box 50 and the fifth substance shown in box 54 undergo fourth reaction 70 to produce a sixth substance shown in sixth box 56.

In another parallel pathway, a seventh substance 58 undergoes fifth reaction 72 to produce an eighth substance shown in seventh box 60. Finally, the joint result of the first two parallel pathways, i.e., the sixth substance shown in sixth box 56, undergoes sixth reaction 74 with the eighth substance shown in box 60 to produce a ninth substance illustrated in ninth box 62.

It will be appreciated by those of skill in the art that the graphical representation of FIG. 1 means that three substances are provided to produce a single chemical product. Specifically, the first substance shown in first box 46, the fourth substance shown in fourth box 52, and the seventh substance shown in seventh box 58 are used to synthesize the ninth substance illustrated in ninth box 62.

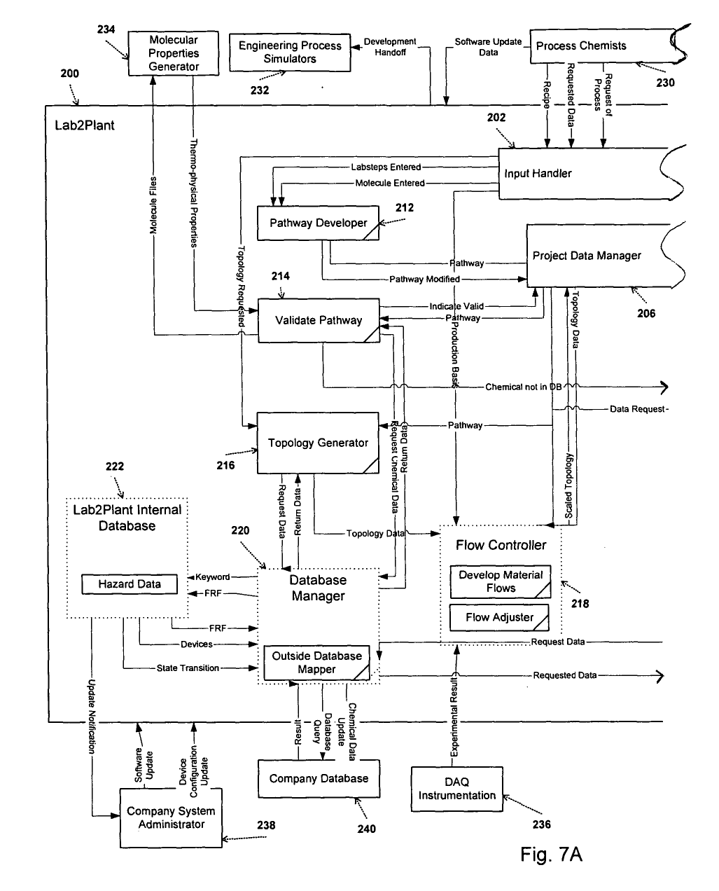

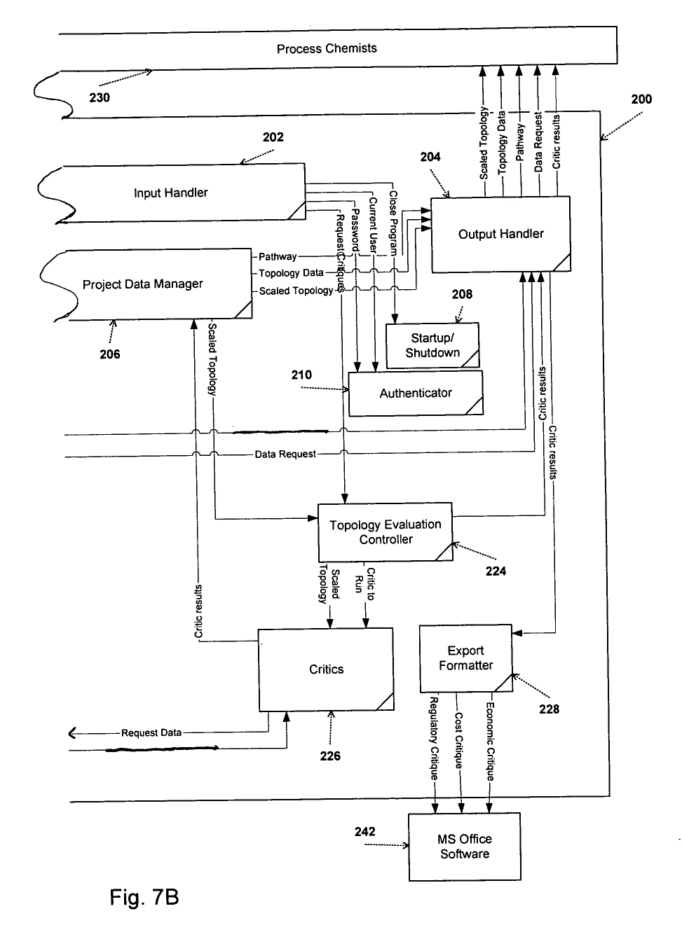

The system of the present invention includes a database of substances, as illustrated in connection with FIG. 7A and FIG. 7B hereof. The database has associated with each chemical of the database properties of the chemical. The identification of the chemicals is used for development of the pathways, and the properties are used for functionality such as the validation of pathways and operation of critics, as is described in greater detail herein.

To add a new pathway using the pathway developer of the present invention, the user simply “clicks” on pathway developer window 20 and then selects the “Add Substance” selection on pathway developer submenu 34 of main menu 22. The user is then prompted to enter the chemical, either by name, by CAS number, or by formula. The entered information is checked against the database. If the chemical does not exist in the database, the user is asked to enter the properties of such chemical. Once the chemical has been successfully identified as existing in the database, a box, such as boxes 46, 48, 50, 52, 54, 56, 58, 60, and 62 will be illustrated on pathway developer window 20. The user may move a generated box on pathway developer window 20 by the point, click, and drag methods or use of the “Copy” and “Paste” selections of file submenu 26 of main menu 22, as is well known in the art.

To specify reactions using the pathway developer of the present invention, the user selects either the “Bind Reaction” selection or the “Double Bind Reaction” selection, as appropriate, from pathway developer submenu 34 of main menu 22. For the “Bind Reaction” selection, the reaction involves only an initial chemical and a second chemical, whereas the “Double Bind Reaction” selection means that two initial chemicals are used to generate a third chemical. For a “Bind Reaction” selection, the user clicks on the box of the initial chemical of the reaction and clicks on the second chemical of that reaction. An arrow representative of the reaction, such as arrow reactions 64, 66, 68, and 72 shown in FIG. 1, is then drawn connecting the initial chemical and the second chemical of that reaction. For a “Double Bind Reaction” selection, the user clicks on each of the two boxes representative of the two initial chemicals, and then clicks on the third chemical of that reaction. The reaction is then illustrated with a multi-pronged arrow, such as arrow reactions 70 and 74 of FIG. 1, is then drawn connecting the two initial chemicals and the third chemical. Once all chemicals are illustrated by a box and reactions by appropriate arrows, the pathway is complete.

For each reaction of the pathway(s) specified using the pathway developer of the present invention, reaction conditions must be specified. According to one embodiment of the present invention, these conditions are specified using the reaction editor of the present invention. The reaction editor is invoked by double-clicking on the reaction arrow or right-clicking on the reaction arrow and selecting “Edit Properties” from the pop-up menu that will appear as a result of such right-click.

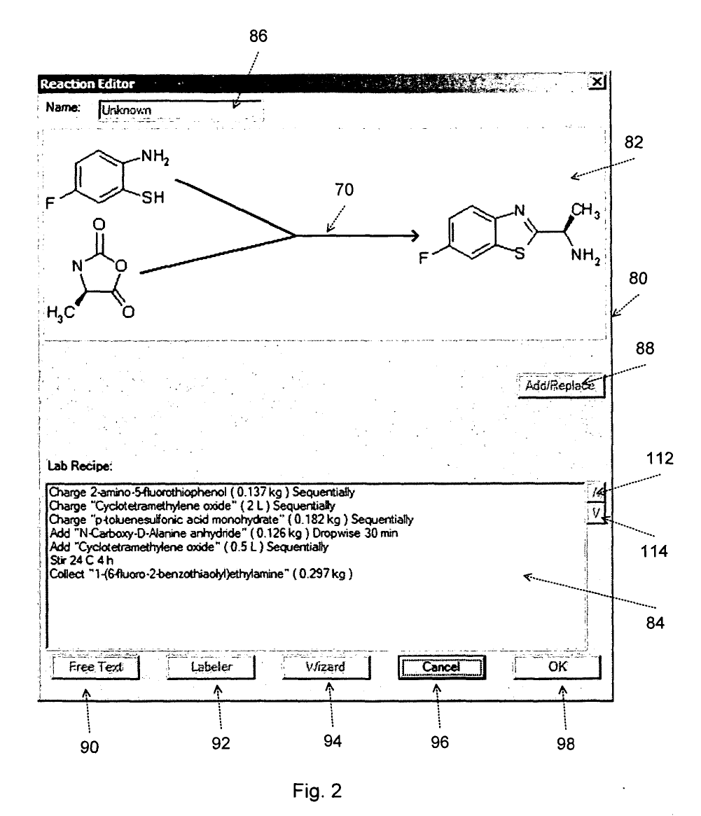

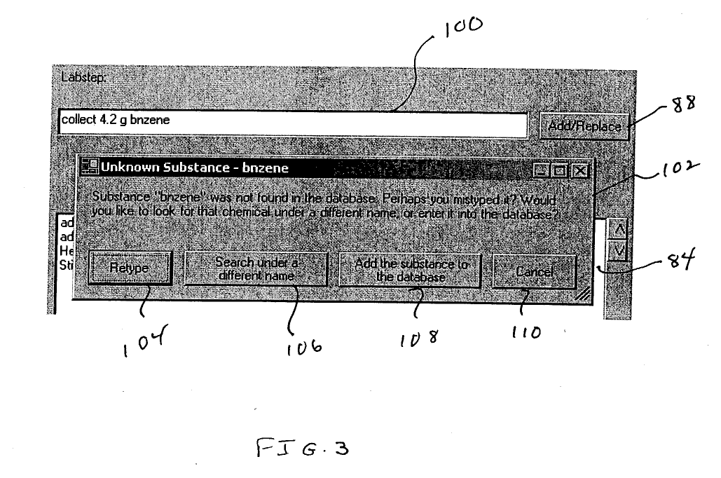

FIG. 2 shows a screen printout of one embodiment of the reaction editor according to the present invention. Specifically, illustrated in FIG. 2 is the reaction editor for fourth reaction 70. Fourth reaction 70 is a double bind reaction. In this embodiment, reaction editor window 80 comprises reaction illustrator window 82 and lab recipe window 84. Reaction illustrator window 82 shows the particular reaction, in this instance fourth reaction 70, for which a lab recipe is to be specified. Lab recipe window 84 shows the lab recipe (reaction conditions) for fourth reaction 70. Reaction editor window 80 further comprises name field 86, Add/Replace button 88, Free Text button 90, Labeler button 92, Wizard button 94, Cancel button 96, and OK button 98.

As shown in FIG. 2, a lab recipe has already been entered for fourth reaction 70. The recipe was created by selecting Add/Replace button 88. When Add/Replace button 88 is selected (such as by pointing and clicking thereon), labstep window 100 (see FIG. 3) is displayed between reaction illustrator window 82 and lab recipe window 84. The appearance of labstep window 100 also causes Free Text button 90, Labeler button 92, Wizard button 94, and OK button 98 to be selectable. By default, the user enters labsteps in labstep window 100 entering a single line of free text. The user may also make use of a wizard button 94 to be prompted to enter the labstep using a series of pull-down menus, radio-buttons, and the like. If the labsteps have already been written in another document, the labsteps can be “pasted” into a text editing window by pressing button 90 to open the full text editor. The user can then edit and rearrange multiple lines of text, i.e., multiple labsteps. When finished, the user clicks “OK” and the system then parses each line in exactly the same way as if the user typed each line into labstep window 100. In addition, the user may select Labeler button 92 to put labels above and below the reaction arrow to make the graphical depiction of the reaction pathway more understandable.

To describe a labstep, certain basic information is required. That information may be described as substance name, amount, units, and command. The chemical and amount of the chemical used in the step is the substance name, amount, and the units. The commands represent the action completed, such as add, stir, react, quench, and cool, for example. Some commands accept a single substance name, while other commands handle a list of substance names. Some commands also have a unit associated therewith. For example, to heat a substance, a temperature must accompany the “heat” command. The specific words used in one embodiment of the present invention are discussed in greater detail herein in association with Table 1, Table 2, and Table 3.

FIG. 3 shows a screen printout of one embodiment of the reaction editor illustrating the error handler according to the present invention. To generate this portion of reaction editor window 80 (see FIG. 2), as previously discussed, the user selected Add/Replace button 88 to give rise to labstep window 100. The user has entered, in free text form, the text “collect 4.2 g bnzene”. In response to this entry, the reaction editor of the present invention, comprising an error handler, detected an unrecognizable word, namely, “bnzene”. The reaction editor then posted error window 102 to inform the user of the unrecognizable word, and to give the user the option to retype the word by selecting Retype button 104 of error window 102, searching the database(s) for acceptable words by selecting Search under a different name button 106, adding the word to the appropriate database by selecting Add the substance to the database button 108, or canceling the entry by selection of Cancel button 110. Note that the reaction editor of the present invention recognized that the unrecognized word was likely to be a substance. Thus, “Search under a different name” button 106 or “Add the substance to the database” button 108 are specifically directed toward identification of a substance, and, if these buttons were selected, the database consulted would be the substance database.

Returning to FIG. 2, located on the side of lab recipe window 84 are up arrow selector 112 and down arrow selector 114. Up arrow selector 112 and down arrow selector 114 are used to move a labstep up or down within the lab recipe. For example, if a user forgot to enter the step cool 25 C, if the step cool 25 C is added using the reaction editor, that entered step will, by default, be added to the bottom of the list. To move the entered labstep to an earlier place in the lab recipe, the user may highlight the cool 25 C labstep by clicking thereon, and then click up arrow selector 112 until the labstep is in the proper location.

Referring now to Table 1, Table 2, and Table 3, there are shown tables of one embodiment of the symbol definition, composite forms, and commands interpreted by the language handler of the present invention. Specifically, Table 1 shows the symbol definitions used according to one embodiment of the language handler of the present invention.

TABLE 1

| Symbol | Definition |
|---|---|
| NAME | General symbol not recognized to be a keyword |
| | or number. Assumed (by the lexer and parser) to be |
| | a chemical name or a device name. |
| TEMP_UNIT | Units of temperature. |
| MASS_UNIT | Units of mass. |
| EQUIV_UNIT | Units of equivalence. |
| MOL_UNIT | Units of mols. |
| VOL_UNIT | Units of volume. |
| TIME_UNIT | Units of time. |
| ACIDITY_UNIT | Units of acidity (i.e. pH) |
| PERCENT_UNIT | Units of percentage (i.e. the symbol ‘%’) |
| NUM | A real, floating point number. |
| NATURAL | A natural number. (Ex: 1, 2, 3 . . .) |
| commands | Each actual command name (appearing below in |
| | quotes) is treated as a separate atomic type. Aliases |
| | to commands (such as Warm to Heat) resolve to the |
| | appropriate atomic type for the command they |
| | refer to, and are not placed in their own atomic |
| | type. This transformation occurs at the lexing level. |
| misc. tokens | Various literal tokens. |

Table 2 shows composite forms used by the reaction editor and language handler of the present invention.

TABLE 2

| | | |
|---|---|---|
| material_unit | : | VOL_UNIT |
| | \| | MASS_UNIT |
| | \| | EQUIV_UNIT |
| | \| | MOL_UNIT |
| temp | : | NUM TEMP_UNIT |
| | \| | ‘room’ ‘temperature’ |
| | \| | ‘room’ ‘temp’ |
| | \| | ‘reflux’ |
| o_temp | : | |
| | \| | temp |
| time | : | NUM TIME_UNIT |
| | \| | ‘overnight’ |
| o_time | : | |
| | \| | time |
| acidity | : | NUM ACIDITY_UNIT |
| percent | : | NUM PERCENT_UNIT |
| count | : | NATURAL ‘times’ |
| | \| | NATURAL ‘time’ |
| o_count | : | |
| | \| | count |
| o_name | : | |
| | \| | NAME |
| material_measure | : | NUM material_unit |
| material_quantity | : | NAME ‘(’ material_measure ‘)’ |
| Material_quantity_list | : | material_quantity |
| | \| | material_quantity_list ‘,’ |
| | | material_quantity |
| material_list | : | NAME |
| | \| | material_list ‘,’ NAME |

Table 3 shows command used by the language handler of the present invention.

TABLE 3

Acidify
acidify : ‘Acidify’ material_quantity acidity
Centrifuge
centrifuge : ‘Centrifuge’
Charge

charge : charge_keyword material_quantity_list
charge_seq charge_drop

charge_keyword : ‘Charge’

| ‘Add’

charge_seq :

| ‘sequentially’

charge_drop :

| ‘dropwise’ time

Collect
collect : ‘Collect’ material_quantity
Concentrate
concentrate : ‘Concentrate’ NAME

| ‘Concentrate’ ‘vacuo’
| ‘Concentrate’

Condense
condense : ‘Condense’ material_quantity NAME
Cool

cool : ‘Cool’ o_temp o_time cool_ice_bath

cool_ice_bath :

| ‘ice’ ‘bath’
| ‘ice’
| ‘icebath’

Crystallize
crystallize : ‘Crystallize’
Distill
distill : ‘Distill’

| ‘Distill’ material_quantity_list

Dissolve
dissolve : ‘Dissolve’ material_quantity material_quantity
Dry
dry : ‘Dry’ NAME

| ‘Dry’

Extract
extract : ‘Extract’ material_quantity
Filter
filter : ‘Filter’ NAME
Grind

grind : grind_keyword material_quantity

Grind_keyword : ‘Grind’

| ‘Pulverize’

Heat

heat : heat_keyword o_temp o_time

heat_keyword : ‘Heat’

| ‘Warm’

Maintain

maintain : maintain_keyword o_temp o_time

Maintain_keyword : ‘Maintain’

| ‘Hold’

Partition
partition : ‘Partition’ material_quantity material_quantity
Pressurize
pressurize : ‘Pressurize’
Purify
purify : ‘Purify’ material_quantity NAME
Quench

quench : ‘Quench’ quench_rapidly NAME

| ‘Quench’ quench_rapidly material_quantity

quench_rapidly :

| ‘rapidly’

React
react : ‘React’ material_quantity_list material_quantity_list
Recrystallize
recrystallize : ‘Recrystallize’ material_quantity
Reflux
reflux : ‘Reflux’ time
Remove
remove : ‘Remove’ material_quantity NAME
Separate
separate : ‘Separate’ material_quantity o_name

| ‘Separate’ ‘organic’ ‘layers’ o_name

Stir
stir : ‘Stir’ o_temp time
Transfer
transfer : ‘Transfer’ material_quantity NAME
Triturate
triturate : ‘Triturate’ material_quantity_list
Wash
wash : ‘Wash’ o_count material_quantity
Yield
yield : ‘Yield’ percent NAME NAME

The language handler of the present invention comprises a lexer and parser. The lexer is used to form at least one word from the individual characters of the textual information entered as a labstep. The parser forms at least one sentence from the at least one word of the textual information. The lab step language is unique in that it achieves a strong resemblance to natural language; a reasonable feat for an artificial language built to deal with a single topic. Three mechanisms are employed to enable this. The first such mechanism is the removal of certain words from consideration within the lexer itself. In one embodiment, the words removed by the lexer are: “a”, “an”, “as”, “at”, “by”, “down”, “for”, “from”, “into”, “of”, “out”, “the”, “to”, “up”, “via”, and “with”. The removal of such extraneous words allows, without consequence to the efficiency of the parser or the integrity of the data, for the user to insert these words at any point, (potentially) making the statements more readable.

The second mechanism employed by the language handler of the present invention is the separation between the name of a command, the command itself, and the possibility of a command having many names. This mechanism is effected in the lexer, where the name is resolved into an internal symbol unique to the command before being handed to the parser. This allows various aliases and synonyms in the chemistry domain to be used properly. A similar substitution occurs in other select data structures (examples include durations, temperatures and acidities), so that, if desired, ideas like “overnight”, “room temperature” and “neutral” can be used.

The third mechanism employed by the language handler of the present invention is likely the most complex. Just as natural language employs pronouns and contextual implication to simplify statements, the language handler of the present invention allows for the omission of certain quantities and identities, with the promise that such information will be recovered at a later stage. The grammar is engineered such that the omissions are permitted only where such recovery is possible. This capability of the language handler is, in fact, not unique to the parser, but is present (as it must be) within the entire system, at appropriate points where such data recovery can occur.

Language handling techniques using lexing and parsing are known in the general art of computer language handling, such as that disclosed in text books such as “Principles of Compiler Design”, Aho, A. and Ullman, J., Addison Wesley, 1977, pg. 72-241. Further, the use of lexing and parsing, language handlers has been made in search engines, such as that used in the Westlaw® and Lexis/Nexisg legal search engines, for example. However, the application of such technology to a chemical process topology system and method to permit for a “natural”, i.e., free form, editor and language handler has not been forthcoming, perhaps due to the complexities of description of chemical reactions. Instead, prior art systems use what is referred to as “wizards” herein for entry of chemical reaction information. Such wizards require the users to make multiple selections and are time consuming to use.

Another issue with the use of wizards is the inflexibility in the order of the entry of the information. By using a lexer and parser for the language handler, the present invention provides the user with the opportunity to express a labstep in the manner preferred by that user. Consider, for example, various representations of the same labstep that can be interpreted by the language handler of the present invention. To add 5 milliliters of water and 10 milliliters of toluene, the user may enter add 5 mL water, toluene (10 mL), or add 5 mL water, 10 mL toluene, or add 5 mL water and 10 mL toluene, or add water (5 mL), toluene (10 mL), or other variations thereof. The system of the present invention understands each of these entries in the same manner.

To further illustrate formats acceptable to the language handler of the present invention, the following is a list of examples. Required information is in bold, and optional information is italicized in these examples:

Acidify with “substance name” (amount unit) to pH

Add to device-name “substance name” (amount unit), “substance name” (amount unit), etc. sequentially dropwise for time-amount unit

Centrifuge

Charge to device-name “substance name” (amount unit), “substance name” (amount unit), etc. sequentially dropwise for time-amount unit

Collect “substance name” (amount unit) OR “SEPARATION PART”

Concentrate in vacuo

Cool to temperature unit for time-amount unit with device-name

Crystallize

Dissolve “substance name” (amount unit) into “substance name” (amount unit)

Distill “substance name” (amount unit), “substance name” (amount unit), etc.

Dry with device-name OR over “substance name” (amount unit) OR “SEPARATION PART” over “substance name” (amount unit)

Thus, the present invention is advantageous over prior art systems in the provision of a language handler that allows the user to enter information in a manner familiar to chemists, that does not require the user to make multiple selections (such as is required in the use of wizards), and permits for differences in expressions of the reactions as used by chemists. Such a language handler is user-friendly and efficient. The free form entry of the present invention is also usable by process chemists and process engineers, and is therefore not necessarily limited to a particular type of user.

Another advantage of the language handler of the present invention is that “fluff” or “syntactic sugar”, elements of the language that make it perhaps easier to read but add no semantic meaning, are eliminated at the lexing level. All prepositions are removed from the parser's view. The removal of prepositions and of other “fluff” or “syntactic sugar” means that one could place extraneous words anywhere in the input, giving the user a good degree of freedom to make the language ‘English-friendly’. It also means that the grammatical rules of the language handler ignore such extraneous words completely.

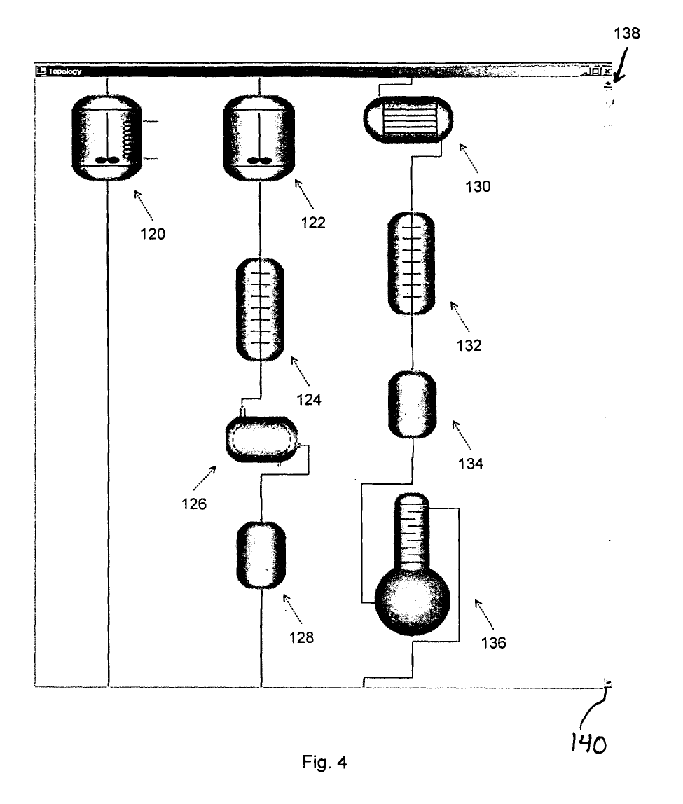

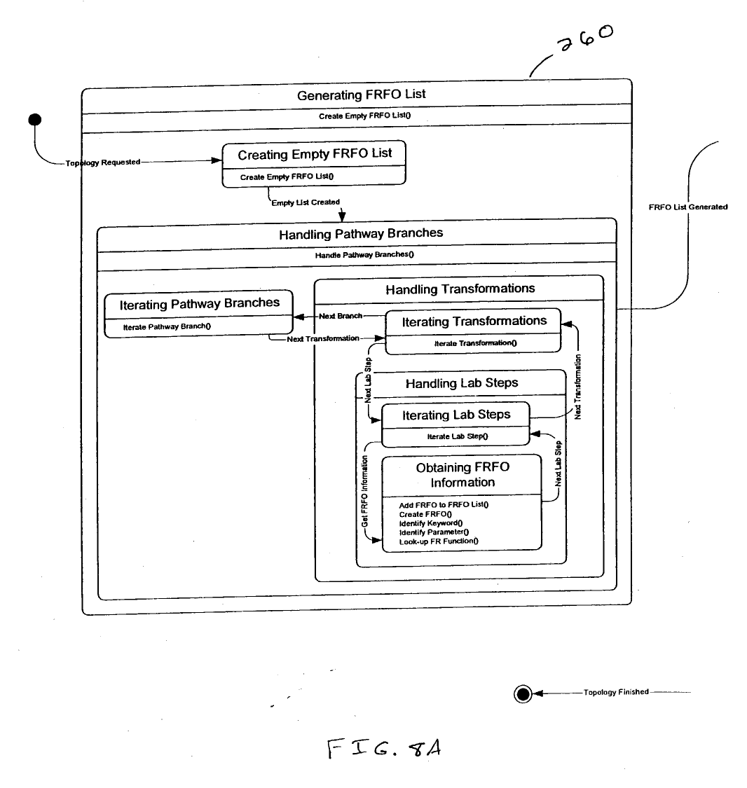

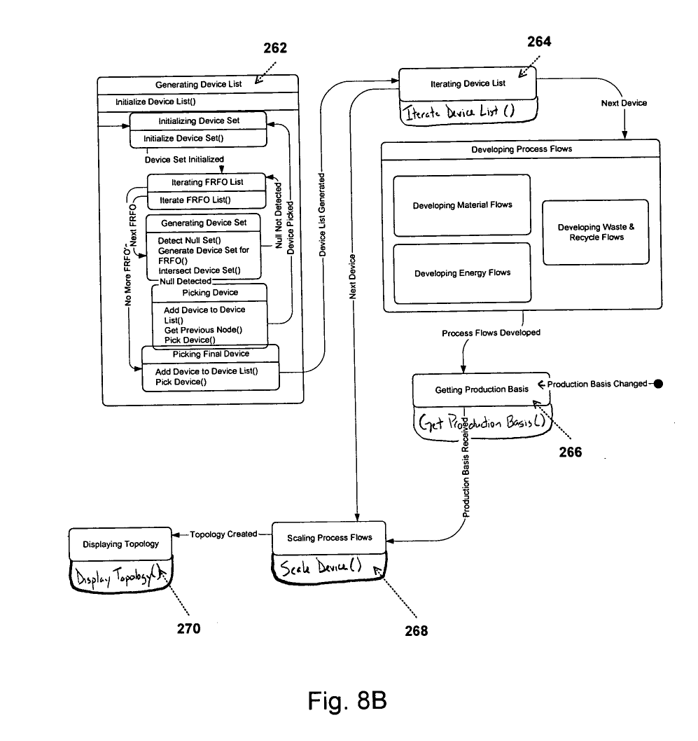

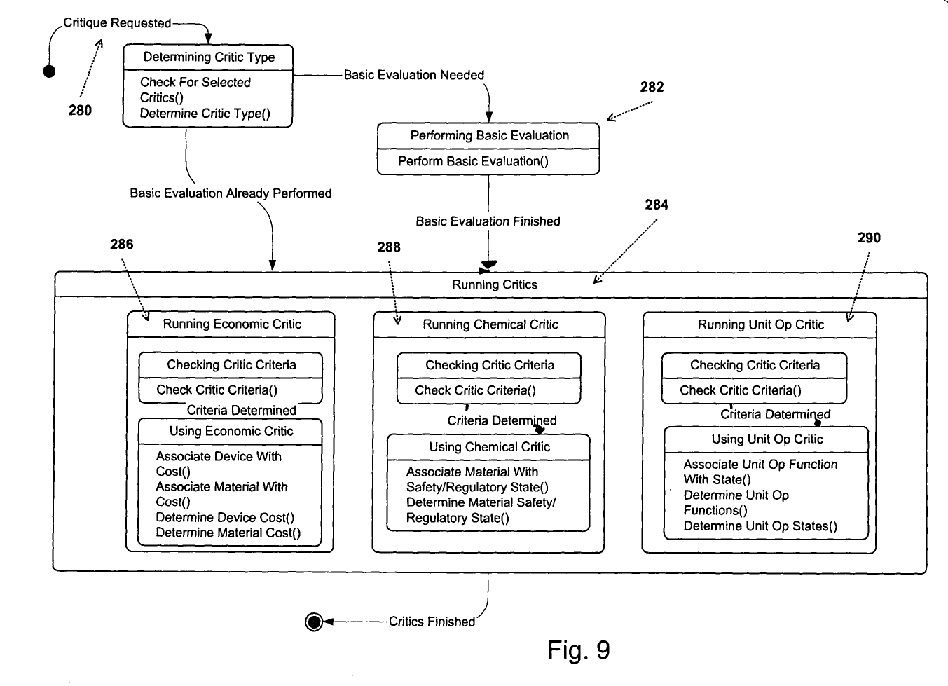

FIG. 4 shows a screen printout of one embodiment of a partial process topology generated by the present invention. The topology illustration of FIG. 4 is displayed in response to selection of Create Topology selection 40 (see FIG. 1). Three topology pathways are shown in the embodiment of FIG. 4. In the first pathway, the system of the present invention has determined that first reactor 120 is required. First reactor 120, as illustrated, is a reactor with agitator and cooling coils. In the second pathway, second reactor 122, first extractor 124, filtration unit 126, and first evaporator 128 are required. In the third pathway, heat exchanger 130, extractor 132, second evaporator 134, and batch distillation unit 136 are required. The topology illustrated in FIG. 4 is only be a portion of the total topology. The user may select up arrow 138 to scroll upward to see what equipment might be required before the equipment shown on FIG. 4, or select down arrow 140 to see what equipment might be required after the equipment shown in FIG. 4. The specific generation of the topology is discussed later herein in connection with FIG. 8A, FIG. 8B, and FIG. 9. However, as shown in FIG. 4, the system of the present invention provides the user with a visual representation of the lab recipe entered and for which the topology was generated.

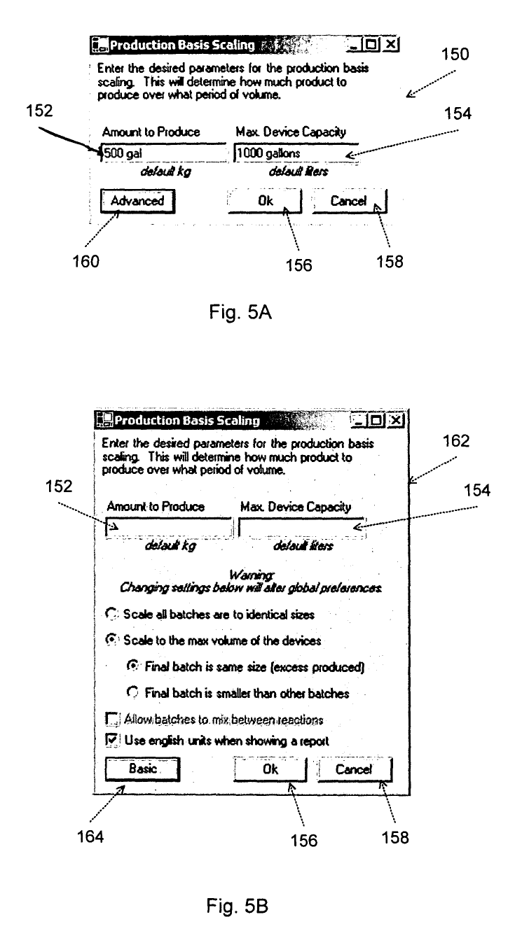

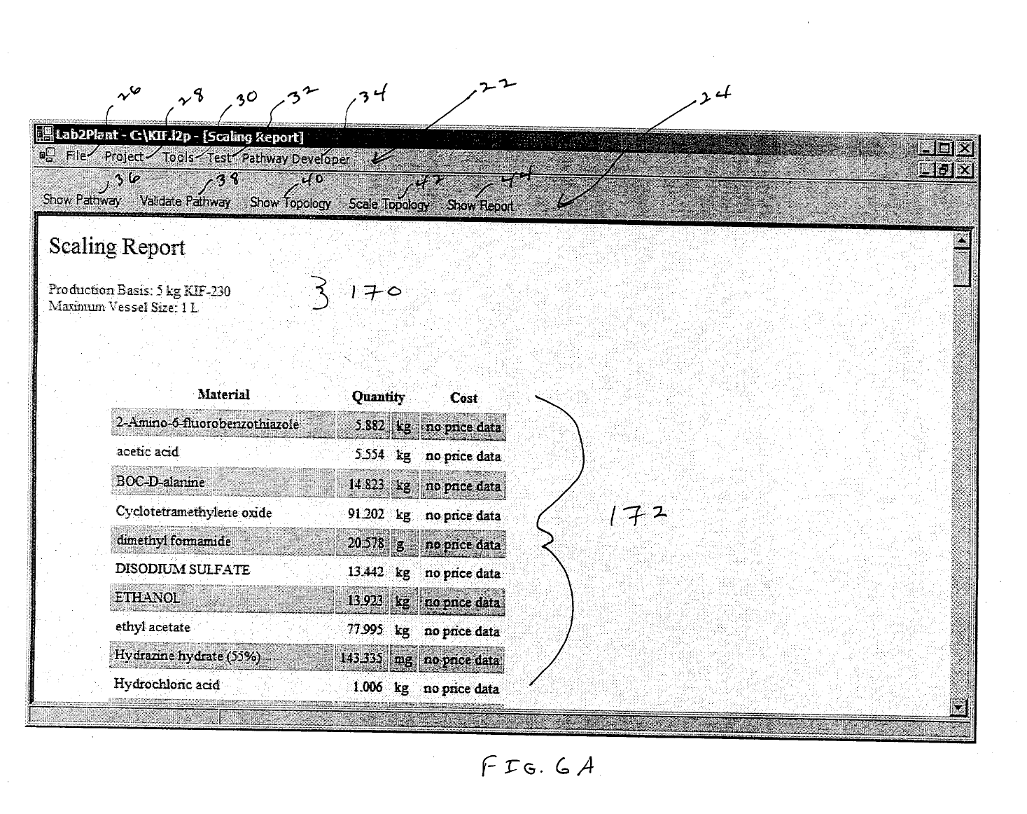

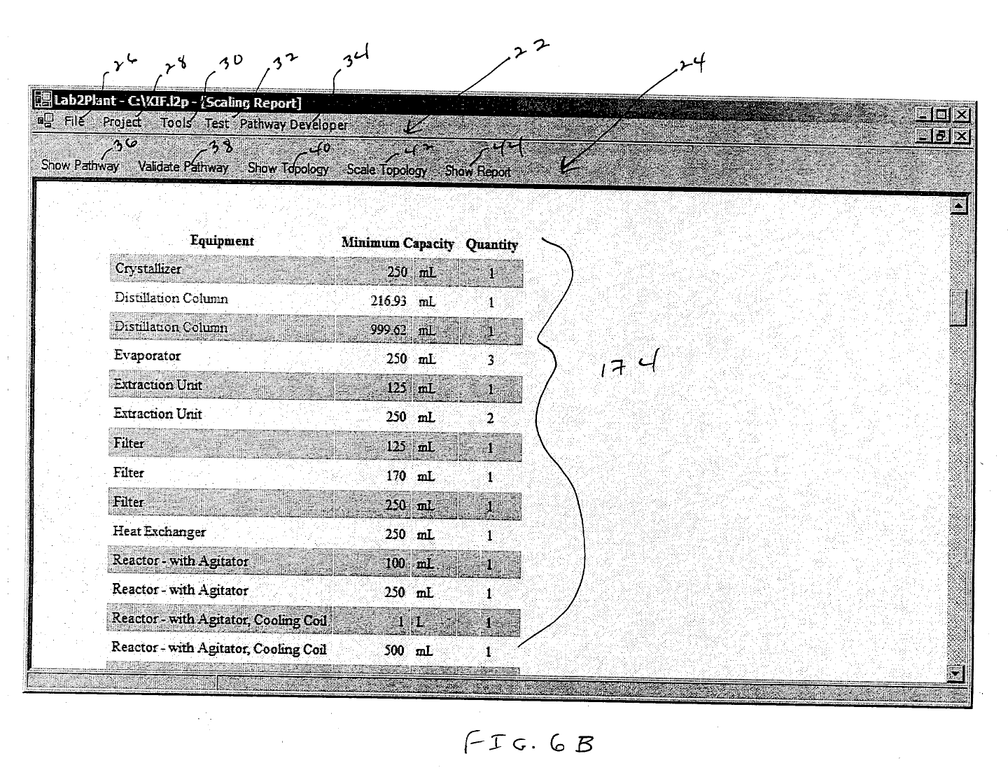

Referring now to FIG. 5A and FIG. 5B, there are shown screen printouts of production basis scaling options according to one embodiment of the present invention. More details about the system requirements and method employed for scaling topology are discussed later herein. Basic production scaling window 150 of FIG. 5A is displayed in response to a user selecting Scale Topology selection 42 (see FIG. 1). Basic production scaling window 150 comprises production amount field 152, maximum device capacity field 154, OK button 156, Cancel button 158, and Advanced button 160. To utilize the basic production scaling capability of the system of the present invention, the user must enter a desired amount of the production chemical to be produced in production amount field 152. The user may also enter a size (volume) in maximum device capacity field 154 to prohibit any vessel (equipment) used in the topology to exceed the specified size. To invoke the basic production scaling feature, the user selects OK button 156. If, instead, the user wishes to cancel the scaling, the user selects Cancel button 158.

To provide more parameters regarding the scaling, the user selects Advanced button 160. In response to such selection, advanced production scaling window 162, such as that of FIG. 5B, is displayed. Like basic production scaling window 150, advanced production scaling window 162 includes production amount field 152, maximum device capacity field 154, OK button 156, and Cancel button 158. Advanced production scaling window 162 also includes Basic button 164. Depression of Basic button 164 results in display of basic production window 150 as shown in FIG. 5A.

The advanced scaling features available to the user are shown in advanced production window 162 of FIG. 5B. Specifically, the user may:

1) Requite that all batches of the chemical product are the same size, by selecting “Scale all batches are to identical sizes”.

2) Require that the system try to fully utilize the maximum capacity specified, i.e., try to fill or come close to filling the equipment specified, by selecting “Scale to the max value of the devices”. Within this option, the user may also specify, by selecting “Final batch is same size (excess produced)”, that it is permissible to produce excess by making all batches, including the final batch, the same size. Alternately, the user may specify, by selecting “Final batch is smaller than other batches”, that excess is not to produced as it is acceptable to allow the final batch to be smaller than the other batches required to produce the amount of the chemical product specified in production amount field 152.

3) If appropriate to the particular pathway, the user may wish to permit batches to be mixed during reactions by selecting “Allow batches to mix between reactions”.

4) The user can opt to show the results using metric or English units. To show the results in English units, “Use English units when showing a report” is specified.

It will be appreciated by those of skill in the art that the options presented in advanced production scaling window 162 provide the chemist with a great deal of flexibility in scaling the topology. However, it will also be appreciated that this flexibility is provided using simple, straightforward parameters for scaling purposes. These parameters are easy for the chemist to understand, and do not require that the user be versed in process engineering.

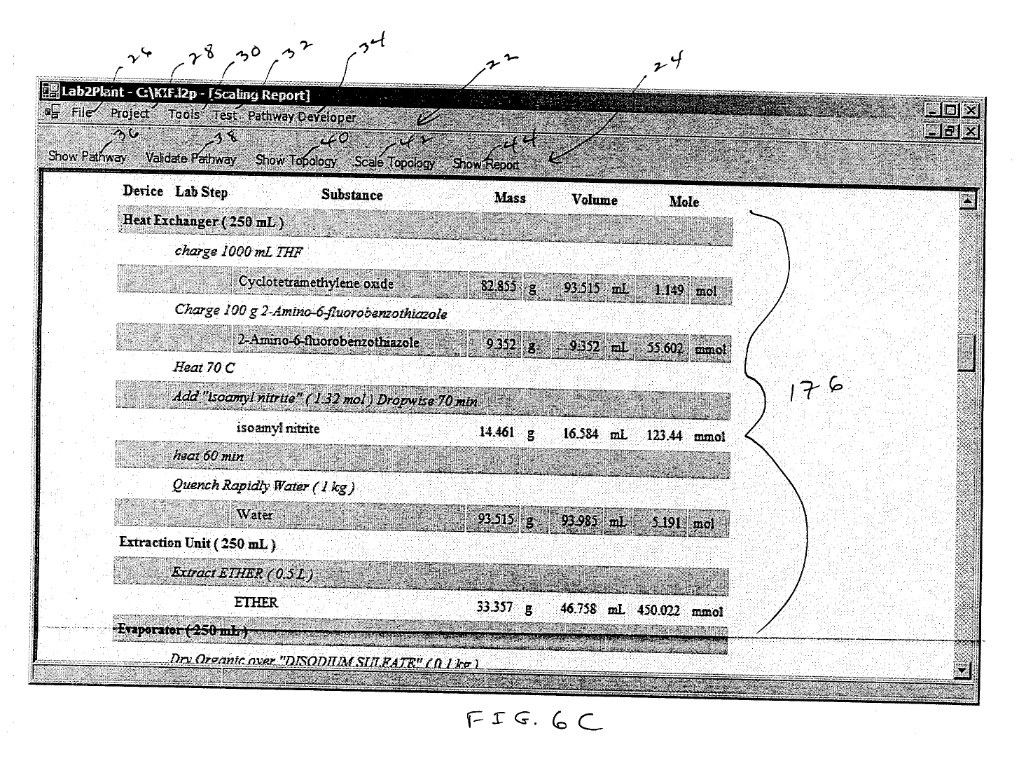

Referring now to FIG. 6A, FIG. 6B, and FIG. 6C, there are shown screen shots of one embodiment of the scaling report according to the present invention. Reports for the system are generated in response to selection of the Show Report selection 44 (see FIG. 1). While FIG. 6A, FIG. 6B, and FIG. 6C show screen printouts of the scaling report, the user may print the scaling report to a printer connected to the system by selecting the selection for “Print” (not shown) under File submenu 26, or by right clicking on the scaling report on the screen, and selecting “Print” from the pop-up window (not shown) displayed.

The portion of the report shown in FIG. 6A demonstrates that the scaling report generated by the system of the present invention includes an identification of the amount of the production chemical to be produced (as entered in production amount field 152 of FIG. 5A and FIG. 5B) and the maximum size of the equipment (as entered in maximum device capacity field 154 of FIG. 5A and FIG. 5B). In the embodiment of FIG. 6A, as shown in parameter area 170, the amount specified is “5 kg KIF-230”, and the maximum vessel size is “1 L”. If other parameters were selected using advanced production scaling window 162 of FIG. 5B, such parameters may also be displayed in parameter area 170. FIG. 6A also includes a partial list of the materials (substances) needed to perform the project (the project consists of one or more pathways entered for production of the chemical product), together with the quantity and costs of such substances in material area 172. In the embodiment of FIG. 6A, no costs are presented due to the fact that the user has not identified such costs in the substance database.

FIG. 6B shows part of another section of a scaling report generated according to the present invention. In the portion shown in FIG. 6B, equipment area 174 shows the equipment to be used, together with the minimum capacity of the equipment and the quantity of that type of equipment required. For example, for this project, one heat exchanger is required, with a minimum capacity of 250 mL.

FIG. 6C shows yet another part of another section of a scaling report generated according to the present invention. In the portion shown in FIG. 6C, topology area 176 presents information about both the equipment and the substances used as related to the labsteps of the project; Not shown in this FIG. 6C, but generated in a report, is the number of batches to be made based on the maximum vessel size. Topology area 175 presents information for each such batch. For example, the heat exchanger is used for the “charge 1000 mL THF” labstep as is 82.855 g (93.515 mL, and 1.149 mol) of cyclotetramethylene oxide. A 250 mL extraction unit is used for the “extract ETHER (0.5 L)” labstep requiring 33.357 g of ETHER.

It will be appreciated by those of skill in the art that the report of the present invention provides useful information about the topology generated by the system. Such information is in easy-to-comprehend format, and does not require that the reader have special process engineering knowledge or understanding.

It will be appreciated by those of skill in the art that the various mechanisms referred as “click”, “point”, “drag”, “double-click”, “right-click”, etc. used in the embodiments of the present invention discussed in association with FIG. 1, FIG. 2, FIG. 3, FIG. 4, FIG. 5A, FIG. 5B, FIG. 6A, FIG. 6B, and FIG. 6C are representative of mechanisms for data entry. These particular mechanisms are used in present day operating systems, such as Windows® by Microsoft Corp., and Mac-OS® used by Apple Corporation, but are not intended to be limiting as to the functionality of the present invention. Even within these operating systems, variations exists for invoking the same functionality, such as “short-cuts”, for example. Also, while a graphical interface is advantageous in the ability to present graphical information to the user and to allow the user to use graphical entry, it is feasible that the present invention be used in connection with a textual operating system such as Microsoft Corp.'s MS-DOS®. The present invention contemplates the use of data entry devices and operating systems known in the art.

FIG. 7A and FIG. 7B collectively show a block diagram of one embodiment of the system of the present invention. As described in connection with FIG. 7A and FIG. 7B, the system of the present invention operates on a personal computer using an Intel® processor by Intel Corporation using the Windows® operating system of Microsoft Corp. However, such a platform and operating system is not intended to be limiting in any respect. The system may operate with other platforms and operating systems, such as Macintosh®t computers from Apple Corporation using the Mac-OS® operating system, Digital Equipment Corporation systems using the VAX® operating system, unix, and other platforms and operating systems known in the art. In addition, the system of the present invention may operate on one or more processors, with such processors housed in a single computer or across multiple computers connected by bidirectional communications mechanisms, such as networks, well known in the art.

Returning now to FIG. 7A and FIG. 7B, collectively, system 200 of the present invention comprises input handler 202, output handler 204 (FIG. 7B), project data manager 206, startup/shutdown manager 208 (FIG. 7B), authenticator manager 210 (FIG. 7B), pathway developer manager 212, validate pathway manager 214, topology generator manager 216, flow controller 218, database manager 220, internal database manager 222, topology evaluation controller 224, critics manager 226, and export formatter manager 228. System 200 is configured to interface with process chemists 230, engineering process simulator 232, molecular properties generator 234, DAQ instrumentation 236, system administrator 238, company database 240, and office software 242.

Input handler 202 and output handler 204 are generally intended for communication of information from and to, respectively, process chemists 230. Project data manager 206 serves as a manager for projects (a project comprises one or more pathways). Startup/shutdown manager 208 (FIG. 7B) serves the administrative functions of either making system 200 available to process chemists 230 or disabling system 200 from access by process chemists 230. Authenticator manager 210 (FIG. 7B) also serves an administrative function in determining whether process chemists 230 have entered a valid user name and password to gain access to system 200. Pathway developer manager 212 manages each pathway entered into system 200 and validate pathway manager 214 serves the function of validating an entered pathway. Topology generator manager 216 generates topology for a project. Flow controller 218 performs the scaling function of system 200 as discussed in connection with FIGS. 5A and 5B. Topology evaluation controller 224 evaluates the topology generated by topology generator 216. Critics manager 226 performs evaluations of pathways and topology based on environmental, costs, and regulatory constraints or issues. Database manager 220 holds data related to substances recognized by system 200, including the names for such substances, and the properties thereof. Internal database manager 222 contains information used by critics manager 226 and information related to administration of system 200. Export formatter manager 228 provides system 200 with the capability to export information from system 200 to external tools, such as office software 248, for example.

According to the embodiment of FIG. 7A and FIG. 7B, process chemists 230 (generally, persons) interface with and are in bidirectional communication with both input handler 202 and output handler 204. Specifically, process chemists 230 provide input handler with requests of process and data, and the lab recipe. Output handler 204 provides process chemists 230 with the selected topology, topology data, pathway information, requests for data, and results generated by critics manager 226.

Input handler 202 accepts inputs from process chemists 230 (such as via a keyboard, mouse, scanner, or other input device known in the art) and is in communication with startup/shutdown manager 208, authenticator manager 210, pathway developer manager 212, and flow controller 218. Upon initial access to system 200 by process chemists 230, input handler 202 communicates with startup/shutdown manager 208 to initiate the remainder of system 200 at the request of process chemists 230. Input handler 202 also communicates bidirectionally with startup/shutdown manager 208 upon shutdown of system 200 to cease access by process chemists 230 to the remainder of system 200. Authenticator manager 210 is in bidirectional communication with input handler 202 to verify that process chemist 202 has entered a valid user name and password to system 200 via input handler 202.

Input handler 202 interfaces with, and is in bidirectional communication with, pathway developer 212 for input of pathways as discussed herein in connection with FIG. 1 and FIG. 2. Process chemists 230 enter pathways, labsteps, and substances via input handler 202. In addition, input handler 202 communicates with flow controller 218 for production parameters as discussed in connection with FIG. 5A and FIG. 5B.

Referring to FIG. 7B, output handler 204 is in communication with process chemist 230, project data manager 206, topology evaluation controller 224, export formatter manager 228, and validate pathway manager 214 (FIG. 7A). Output handler 204 requests data of the type needed by system 200 (such as pathway information, substance identification and properties, scaling parameters, and the like) from process chemist 230. In addition, output handler 204 provides process chemist 230 with information and data such as that about pathways, topology, and critics. Output handler 204 is in communication with project data manager 206 to accept information about projects and pathways, and scaled and unscaled topology. Topology evaluation controller 224 communicates with output handler 204 to provide output handler 204 with results of the topology evaluation, including results performed by critics manager 226. To inform process chemists 230 that an entered substance is not recognizable, output handler 204 is connected to validate pathway manager 214. To make data from system 200 available to external office type programs, output handler 204 provides information to export formatter manager 228.

As previously mentioned, project data manager 206 is connected to output handler 204. In addition, project data manager 206 is in communication with pathway developer manager 212, validate pathway manager 214, topology generator manager 216, flow controller 218, topology evaluation controller 224, and critics manager 226. Project data manager 206 accepts pathway information from pathway developer manager 212. Project data manager 206, in turn, sends pathway information to validate pathway manager 214. Validate pathway manager 214 provides an indicator to project data manager 206 in the event a pathway is invalid. Project data manager 206 also bidirectionally communicates topology information with flow controller 218 and provides scaled topology information to topology evaluation controller 224. Further, project data manager 206 accepts the results of critics analysis from critics manager 226.

Pathway developer manager 212 communicates with input handler 202 and project data manager 206 as already described. Validate pathway manager 214, in addition to communication with project data manager 206 and output handler 204, communications with database manager 220, and, externally, with molecular properties generator 234.

Topology generator 216 is connected to project data manager 206 and to input handler 202 as described hereinabove. In addition, topology generator 216 is connected to flow controller 281 and database manager 220. Topology generator 216 sends flow controller 218 topology data. Topology generator 216 exchanges requests and information from database manager 220 for the purpose of developing a topology.

Flow controller 218 is connected to input handler 202, project data manager 206, topology generator 216, and DAQ instrumentation 236. The connections with input handler 202, project data manager 206, and topology generator 216 have already been described herein. With regard to DAQ (data acquisition) instrumentation 236, flow controller 219 may be connected to DAQ instrumentation to accept experimental data from DAQ instrumentation 236. Such experimental data may comprise, for example, actual flow rates, stream compositions, etc. and be used by flow controller 218 for the purpose(s) of providing a more accurate prediction of the scaled-up material flows.

Database manager 220 is connected to topology generator 216 and validate pathway manager 212 as described hereinabove. In addition, database manager 220 is connected to company database 220 as described hereinafter. Further, database manager 220 is in bidirectional communication with system database 222 and critics manager 226. The bidirectional communication between database manager 220 and system database 220 allows for database manager 220 to provide to system database 222 with keywords and functional representation function (“FRF”), and allows system database 222 to send information about devices (equipment), FRF, and state transitions to database manager 220.

System database 222 is, as previously discussed, in bidirectional communication with database manager 220. In addition, system database 222 may send update notification information to system administrator 238.

Referring now to FIG. 7B, topology evaluation controller 224 is connected to project data manager 206, input handler 202, and output handler 204 as previously described. In addition, topology evaluation controller is in communication with critics manager 226 for the provision of a request for operation of the critics handled by critics handler 226 and the provision of scaled topology information to critics manager 226.

Critics manager 226 handles economic, environmental, cost, and other critics in a manner similar to that described in Miller et al. In addition, as previously described, critics manager 226 communicates with project data manager 206 and database manager 220. Export formatter handler 228 receives output and instructions from output handler 204 to subsequently provide properly formatted data and information to an external program. Thus, as illustrated, export formatter manager 228 is connected to output handler 204 and to office software 242.

As introduced above, system 200 is configured to interface externally with process chemists 230, engineering process simulator 232, molecular properties generator 234, DAQ instrumentation 236, system administrator 238, company database 240, and office software 242. Process chemists 230 are generally users of system 200, and system administrator 238 is generally an individual assigned the task of administering system 200. Such administration generally involves the establishment and maintenance of user names and passwords, performance of updates to system 200, testing of system 200, and configuration of system 200.

Engineering process simulator 232 may accept information from system 200 for the purpose of further developing or executing a topology generated by system 200. Molecular properties generator 234 is in bidirectional communication with validate pathway manager 214 for the purpose of accepting thermo-physical properties of substances from validate pathway manager 214, and providing validate pathway manager 214 with molecular properties in response thereto.

DAQ instrumentation 236 is in communication with flow controller 218 for the purpose of providing experimental results to flow controller 218. Such experimental results may be used to more accurately predict the scale-up characteristics of the system. Otherwise, the software attempts to predict the scale-up properties (such as heats of reaction, selectivity, yield kinetics, etc.) Another external component in bidirectional communication with system 200 is company database 240. Specifically, company database 240 is in bidirectional communication with database manager 220. Company database 240 accepts updated chemical data held in database manager 220 and also accepts inquiries about chemicals from database manager 220. In response to inquiries from database manager 240, company database 240 provides database manager 220 with results. In this manner, database manager 220 seeks information about one or more entered substances from company database 240. Thus, if the company using system 200 maintains its own substance database, database manager 220 may be in sync with such database.

As shown in FIG. 7B, system 200 also communicates with office software 242. Office software 242 may comprise various well-known office applications, such as databases, word processors, spreadsheets, and the like, for example. Office software 242 is in communication with export formatter 228 of system 200 to accept information for further processing by office software 242. Such information may include, for example, economic information, cost information, or the results of any of the critics generated by critic manager 226.

It will be appreciated by those of skill in the art that any or all of the external functionality may be included within system 200 and still be within the scope of the invention. Further, while perhaps not resulting in the most desirable system, certain functionality identified within system 200 may be eliminated. Such functionality may include critics related to environmental, costs, or regulatory information, for example.

Referring now to FIG. 8A and FIG. 8B, collectively, there is shown a state diagram for generating process topology according to one embodiment of the system of the present invention. FIG. 8A and FIG. 8B actually illustrate the process of identification of equipment (devices) and process flows as determined by the topology generator of the present invention, together with the scaling of the process flows and displaying the topology.

The purpose of the topology generator (see topology generator 216 in FIG. 7A) is to generate a list of devices that will perform the combined functional representation function object (“FRFOs”) of a given pathway. There should be one device associated for a given FRFO but a device can have more than one FRFO associated with it. Table 4 identifies keywords (commands) with their associated equipment and the type of equipment required to perform such command and function according to one embodiment of the present invention.

TABLE 4

| Keyword | Function | Equipment |
|---|---|---|
| React | Material_Loading | Reactor |
| Acidify | Material_Loading | Reactor |
| Charge | Material_Loading | Reactor |
| Dissolve | Material_Loading | Reactor |
| Stir | Material_Mixing | Agitated Reactor |
| Heat | Heat_Transfer-Heating | Coil Heated Reactor |
| Hold | Heat_Transfer-steady_state | Coil Heated Reactor |
| Cool | Heat_Transfer-Cooling | Coil Cooled Reactor |
| Hold | Heat_Transfer-steady_state | Coil Cooled Reactor |
| Cool | Heat_Transfer-Cooling | Jacketed Reactor |
| Hold | Heat_Transfer-steady_state | Jacketed Reactor |
| Heat | Heat_Transfer-Heating | Jacketed Reactor |
| React | Material_Loading | Stirred, Jacketed |
| | | Reactor |
| Cool | Heat_Transfer-Cooling | Stirred, Coil Cooled |
| | | Reactor |
| Hold | Heat_Transfer-steady_state | Stirred, Coil Cooled |
| | | Reactor |
| Hold | Heat_Transfer-steady_state | Stirred, Coil Heated |
| | | Reactor |
| Heat | Heat_Transfer-Heating | Stirred, Coil Heated |
| | | Reactor |
| Pressurize | Pressurization | Pressurized Reactor |
| Acidify | Material_Loading | Pressurized Reactor |
| Charge | Material_Loading | Pressurized Reactor |
| Dissolve | Material_Loading | Pressurized Reactor |
| Stir | Material_Mixing | Pressurized, Stirred |
| | | Reactor |
| Reflux | Heat_Transfer-reflux | any Reactor w/ |
| | | Condenser |
| Triturate | Pulverize | Crusher |
| Yield | Data | no equipment-reset |
| | | and force selection |
| Collect | Collection | no equipment-reset |
| | | and force selection |
| Transfer | Material_Transfer | no equipment-reset |
| | | and force selection |
| Heat | Heat_Transfer-Heating | Heat Exchanger |
| Hold | Heat_Transfer-steady_state | Heat Exchanger |
| Cool | Heat_Transfer-Cooling | Heat Exchanger |
| Distill | Separation-liquid/liquid_VLE | Distillation Column |
| Condense | Separation-low_P_VLE | Distillation Column |
| Concentrate | Separation-low_P_VLE | Distillation Column |
| in vacuo | Separation-low_P_VLE | Distillation Column |
| Extract | Separation-liquid/liquid_Kd | Extraction Unit |
| Filter | Separation-solid/liquid | Filtration Unit |
| Wash | Separation-solid/solid-minor | Filtration Unit |
| Centrifuge | Separation-solid/liquid | Centrifuge |
| Partition | Separation-2_liquid_phase | Centrifuge |
| Crystallize | Separation-solid_phase_generation | Crystallizer |
| Recrystallize | Separation-solid/solid-major | Crystallizer |
| Dry | Separation-final_liquid_removal | Dryer |
| Concentrate | Separation-liquid_removal | Evaporator |
| Condense | Separation-liquid_removal | Evaporator |
| Dry | Separation-final_liquid_removal | Evaporator |
| Condense | Separation-low_P_VLE | Reactor w |
| | | condenser & |
| | | vacuum pump |
| Concentrate | Separation-low_P_VLE | Reactor w |
| | | condenser & |
| | | vacuum pump |
| in vacuo | Separation-low_P_VLE | Reactor w |
| | | condenser & |
| | | vacuum pump |

Table 5 identifies the types of equipment (devices) supported in one embodiment of the system of the present invention.

TABLE 5

Equipment - complete list
Reactor (see add-ons, below)
Stirred Reactor
Coil Heated Reactor
Coil Cooled Reactor
Jacketed Reactor
Stirred, Jacketed Reactor
Stirred, Coil Cooled Reactor
Stirred, Coil Heated Reactor
Pressurized Reactor
Pressurized, Stirred Reactor
Reactor w/Condenser
Stirred, jacketed Reactor w/
Condenser
Crusher
Pressurized Vessel
Heat Exchanger
Distillation Column
Extraction Unit
Filtration Unit
Centrifuge
Crystallizer
Dryer
Evaporator
Reactor add-ons
Condenser
Vacuum pump
Heating coils
Cooling coils
Jacket
HX_pump-around
Agitator

Returning to FIG. 8A and FIG. 8B, for a particular project, topology generator 216 works with other managers of the system to perform the basic functions of generating FRFO list 260, generating device list 262, and iterating device list 264. FIG. 8A and FIG. 8B also illustrate the function of developing process flows 266 performed by flow controller 218 (see FIG. 7A). In addition, FIG. 8A and FIG. 8B illustrate the functions of getting production basis 266, scaling process flows 268, and displaying topology 270. Topology generator 216 begins by converting the lab recipe's keywords and parameters into FRFOs using the language handler of the present invention in response to input by input handler 202. The conversion of the lab recipe is performed by finding the FRF associated with each keyword and then associating the parameters of that keyword into a FRFO. Topology generator 216 then adds the FRFOs to the FRFO LIST in the same order that they are found in the recipe.

After the function of generating FRFO list 260 is complete, topology generator 216 continues by iterating through the complete FRFO LIST to generate the device(s) necessary at generating device list 262. For each FRFO, topology generator 216 creates a DEVICE SET of all of the devices that can perform that FRFO. If the FRFO is the first one on the FRFO LIST, then topology generator 216 then moves on to the second FRFO on the FRFO LIST and creates a DEVICE SET of devices that can perform that FRFO. Topology generator 216 then intersects the two DEVICE SETs. After the intersection between DEVICE SETS is made, and assuming there are still viable devices on INTERSECTED DEVICE SET, topology generator 216 moves on to the next FRFO, generates a DEVICE SET for the FRFO, and intersects the DEVICE SET for that FRFO with the INTERSECTED DEVICE SET. This procedure continues until the intersection of the two sets results in a null set of no devices.

If a null set is returned, topology generator 216 returns to the previous INTERSECTED DEVICE SET and chooses the simplest device in the set. This device will be added to the DEVICE LIST and associated with all of the FRFOs that it will perform. After the device has been added to the DEVICE LIST, topology generator 216 returns to the DEVICE SET of the first FRFO not associated with the selected device. An example of this process is to consider four FRFOs, namely, F1, F2, F3, and F4. Topology generator 216 intersects the DEVICE SETS of F1 and F2. A null is not returned so topology generator 216 continues on to F3 and generates a DEVICE SET for F3 and intersects it with the INTERSECTED DEVICE SET of F1 and F2. This intersection results in a null so topology generator 216 goes back to the INTERSECTED DEVICE SET of F1 and F2, picks a device, adds the device to the DEVICE LIST, and associates the device with F1 and F2. Topology generator 216 then returns to the DEVICE SET of F3 and continues as before.

When topology generator 216 reaches the last FRFO in the FRFO LIST, there exists two possible scenarios. In one scenario, when the INTERSECTED DEVICE SET is intersected with the final DEVICE SET, a null is produced and a device is selected, but there is still the remaining DEVICE SET that cannot be intersected with anything. In the second scenario, the INTERSECTED DEVICE SET is intersected with the final DEVICE SET and a null is not produced. The simple solution for both of these cases is to cause topology generator 216 to automatically select a device from the final INTERSECTED DEVICE SET when it reaches the end of the FRFO LIST.

A few exceptions to the foregoing exist. If the FRFO happens to involve the keyword “TRANSFER”, then topology generator 216 will react differently than described above. Specifically, the presence of the keyword TRANSFER signals topology generator 216 to select a device from the current INTERSECTED DEVICE SET and to add the device to the DEVICE LIST. The TRANSFER FRFO also specifies what device to transfer to. In this case, the DEVICE SET for the TRANSFER FRFO will only be the device specified by the FRFO. Topology generator 216 then continues on as described before.

The second exception deals with branching pathways. Topology generator 216 should be able to handle branching pathways. The FRFO list of each branch is separate from the other branch. Therefore, topology generator 216 iterates both individually to the point where the branches meet. When topology generator 216 finds two branches coming together, topology generator 216 takes the INTERSECTED DEVICE LIST from both branches and intersect them. Then, topology generator 216 continues on and works the same as described before.

To illustrate the generation of a topology according to the present invention, below is an example showing each labstep of a lab recipe, and the FRF and FRFO for each labstep:

| Lab Recipe | FRF | FRFO |
|---|---|---|
| charge reactor with glycerol(10 ml, 10 g) | Material_Loading | Material_Loading(glycerol, 10 mL, 10 g) |
| add K2CO3(0.43 g) | Material_Loading | Material_Loading(K2CO3, 0.43 g) |
| add Case Study 2(5.0 g) | Material_Loading | Material_Loading(Case Study 2, 5.0 g) |
| heat to 115 degrees C. | Heat_Transfer-Heating | Heat_Transfer-Heating(115° C.) |
| add benzonitrile(3.5 g) | Material_Loading | Material_Loading(benzonitrile, 3.5 g) |
| stir for 840 min | Material_Mixing | Material_Mixing(840 min) |
| Cool | Heat_Transfer-Cooling | Heat_Transfer-Cooling |
| add water(5 g) | Material_Loading | Material_Loading(water, 5 g) |
| Filter | Separation-solid/liquid | Separation-solid/liquid |
| wash with water(2 g) | Separation-solid/solid-minor | Separation-solid/solid-minor(water, 2 g) |
| wash with MeCl2 (2 g) | Separation-solid/solid-minor | Separation-solid/solid-minor(MeCl2, 2 g) |
| Dry | Separation-final_liquid_removal | Separation-final_liquid_removal |
| collect Case Study 3(6.4 g) | Collection | Collection(Case Study 3, 6.4 g) |
| yield 95% based on Case Study 2 | Data | Data(95%, Case Study 2) |

From the above FRFO, the device set and intersection device set is shown below:

| FRFO | Device Set | Intersected Device Set |
|---|---|---|
| Material_Loading(glycerol, 10 mL, 10 g) | Pressurized Reactor | Pressurized Reactor |
| | Pressurized, Stirred Reactor | Pressurized, Stirred Reactor |
| | Reactor w/Condenser | Reactor w/Condenser |
| | Jacketed Reactor | Jacketed Reactor |
| | Reactor | Reactor |
| | Stirred Reactor | Stirred Reactor |
| | Coil Heated Reactor | Coil Heated Reactor |
| | Coil Cooled Reactor | Coil Cooled Reactor |
| | Stirred, Jacketed Reactor | Stirred, Jacketed Reactor |
| | Stirred, Coil Cooled Reactor | Stirred, Coil Cooled Reactor |
| | Stirred, Coil Heated Reactor | Stirred, Coil Heated Reactor |
| Material_Loading(K2CO3, 0.43 g) | Pressurized Reactor | Pressurized Reactor |
| | Pressurized, Stirred Reactor | Pressurized, Stirred Reactor |
| | Reactor w/Condenser | Reactor w/Condenser |
| | Jacketed Reactor | Jacketed Reactor |
| | Reactor | Reactor |
| | Stirred Reactor | Stirred Reactor |
| | Coil Heated Reactor | Coil Heated Reactor |
| | Coil Cooled Reactor | Coil Cooled Reactor |
| | Stirred, Jacketed Reactor | Stirred, Jacketed Reactor |
| | Stirred, Coil Cooled Reactor | Stirred, Coil Cooled Reactor |
| | Stirred, Coil Heated Reactor | Stirred, Coil Heated Reactor |
| Material_Loading(Case Study 2, 5.0 g) | Pressurized Reactor | Pressurized Reactor |
| | Pressurized, Stirred Reactor | Pressurized, Stirred Reactor |
| | Reactor w/Condenser | Reactor w/Condenser |
| | Jacketed Reactor | Jacketed Reactor |
| | Reactor | Reactor |
| | Stirred Reactor | Stirred Reactor |
| | Coil Heated Reactor | Coil Heated Reactor |
| | Coil Cooled Reactor | Coil Cooled Reactor |
| | Stirred, Jacketed Reactor | Stirred, Jacketed Reactor |
| | Stirred, Coil Cooled Reactor | Stirred, Coil Cooled Reactor |
| | Stirred, Coil Heated Reactor | Stirred, Coil Heated Reactor |
| Heat_Transfer-Heating(115° C.) | Coil Heated Reactor | Coil Heated Reactor |
| | Jacketed Reactor | Jacketed Reactor |
| | Stirred, Jacketed Reactor | Stirred, Jacketed Reactor |
| | Stirred, Coil Heated Reactor | Stirred, Coil Heated Reactor |
| Material_Loading(benzonitrile, 3.5 g) | Pressurized Reactor | Coil Heated Reactor |
| | Pressurized, Stirred Reactor | Jacketed Reactor |
| | Reactor w/Condenser | Stirred, Jacketed Reactor |
| | Jacketed Reactor | Stirred, Coil Heated Reactor |
| | Reactor | |
| | Stirred Reactor | |
| | Coil Heated Reactor | |
| | Coil Cooled Reactor | |
| | Stirred, Jacketed Reactor | |
| | Stirred, Coil Cooled Reactor | |
| | Stirred, Coil Heated Reactor | |
| Material_Mixing(840 min) | Pressurized, Stirred Reactor | Stirred, Jacketed Reactor |
| | Stirred Reactor | Stirred, Coil Heated Reactor |
| | Stirred, Jacketed Reactor | |
| | Stirred, Coil Cooled Reactor | |
| | Stirred, Coil Heated Reactor | |
| Heat_Transfer-Cooling | Jacketed Reactor | Stirred, Jacketed Reactor |
| | Coil Cooled Reactor | |
| | Stirred, Jacketed Reactor | |
| | Stirred, Coil Cooled Reactor | |
| Material_Loading(water, 5 g) | Pressurized Reactor | Stirred, Jacketed Reactor |
| | Pressurized, Stirred Reactor | |
| | Reactor w/Condenser | |
| | Jacketed Reactor | |
| | Reactor | |
| | Stirred Reactor | |
| | Coil Heated Reactor | |
| | Coil Cooled Reactor | |
| | Stirred, Jacketed Reactor | |
| | Stirred, Coil Cooled Reactor | |
| | Stirred, Coil Heated Reactor | |
| Separation-solid/liquid | Filtration Unit | null |
| | Centrifuge | |

At this point topology generator 216 goes back to the previous INTERSECTED DEVICE SET and selects a device. There is only one device in the set, so topology generator 216 picks the “Stirred, Jacketed Reactor” element, adds it to the DEVICE LIST, and associates the device with all of the FRFOs it performs. Topology generator 216 then returns to the Separation-solid/liquid FRFO and begins anew.

| | | |
|---|---|---|
| Separation-solid/liquid | Filtration Unit | Filtration Unit |
| | Centrifuge | Centrifuge |
| Separation-solid/solid-minor(water, 2 g) | Filtration Unit | Filtration Unit |
| Separation-solid/solid-minor(MeCl2, | Filtration Unit | Filtration Unit |
| 2 g) | | |
| Separation-final_liquid_removal | Dryer | null |
| | Evaporator | |

At this point topology generator 216 goes back to the previous INTERSECTED DEVICE SET and selects a device. There is only one device in the set so the topology generator picks the Filtration Unit, adds it to the DEVICE LIST, and associates the device with all of the FRFOs it performs. Topology generator then returns to the Separation-final_liquid_removal FRFO and begins anew.

| | | |
|---|---|---|
| Separation-final_liquid_removal | Dryer | Dryer |
| | Evaporator | Evaporator |
| Collection(Case Study 3, 6.4 g) | Process Vessel | Null |
| | Agitator | |
| | Pressurized Vessel | |
| | Storage Drum | |
| | Jacketed Vessel | |

At this point topology generator 216 goes back to the previous INTERSECTED DEVICE SET and selects a device. There are two devices in the set, so topology generator 216 selects the simplest of the two. The simplest device is the Dryer. Thus, topology generator 216 selects the Dryer, adds it to the DEVICE LIST, and associates the device with all of the FRFOs it performs. Topology generator 216 then returns to the Collection (Case Study 3, 6.4 g) FRFO and begins anew.

| | | |
|---|---|---|
| Collection(Case Study 3, | Process Vessel | Process Vessel |
| 6.4 g) | Agitator | Agitator |
| | Pressurized Vessel | Pressurized Vessel |
| | Storage Drum | Storage Drum |
| | Jacketed Vessel | Jacketed Vessel |
| Data(95%, Case Study 2) | Process Vessel | Process Vessel |
| | Agitator | Agitator |
| | Pressurized Vessel | Pressurized Vessel |
| | Storage Drum | Storage Drum |
| | Jacketed Vessel | Jacketed Vessel |
| END OF FRFO LIST | | |

When topology generator 216 reaches the end of the list, topology generator 216 selects a device from the final INTERSECTED DEVICE SET. The simplest device on the list is a Storage Drum, so topology generator 216 selects the Storage Drum, adds it to the DEVICE LIST, and associates the device with all of the FRFOs it performs.

As a result of the above example, the complete device list for the example lab recipe is as follows.

| FRFO | DEVICE LIST |
|---|---|
| Material_Loading(glycerol, 10 mL, 10 g) | Stirred, Jacketed Reactor #1 |
| Material_Loading(K2CO3, 0.43 g) | Stirred, Jacketed Reactor #1 |
| Material_Loading(Case Study 2, 5.0 g) | Stirred, Jacketed Reactor #1 |
| Heat_Transfer-Heating(115° C.) | Stirred, Jacketed Reactor #1 |
| Material_Loading(benzonitrile, 3.5 g) | Stirred, Jacketed Reactor #1 |
| Material_Mixing(840 min) | Stirred, Jacketed Reactor #1 |
| Heat_Transfer-Cooling | Stirred, Jacketed Reactor #1 |
| Material_Loading(water, 5 g) | Stirred, Jacketed Reactor #1 |
| Separation-solid/liquid | Filtration Unit #1 |
| Separation-solid/solid-minor(water, 2 g) | Filtration Unit #1 |
| Separation-solid/solid-minor(MeCl2, 2 g) | Filtration Unit #1 |
| Separation-final_liquid_removal | Dryer #1 |
| Collection(Case Study 3, 6.4 g) | Storage Drum #1 |
| Data(95%, Case Study 2) | Storage Drum #1 |

It will be appreciated by those of skill in the art that the development of topology according to the present invention is very efficient. Where feasible, a single device is identified for use in handling multiple labsteps. Consider, for example, four labsteps involving the process of adding two chemicals, cooling the chemicals, and stirring the chemicals. The topology creation subsystem of the present invention is able to determine that a single piece of equipment can be used for all these steps, i.e., a single reactor with jacket and agitator add-ons. If the chemicals were heated instead of cooled, a reactor with agitator and heating coils may be specified by the system. If more intermediate chemicals or more complicated processes were involved in the labsteps, it is likely that more devices would be required.

It will also be appreciated that the automatic generation of required equipment may, in and of itself, alert the user of potential problems with the viability of the proposed topology. For example, an equipment (or unit operation) critic may identify a particular distillation step as unsuitable to scale because of a small difference in relative volatilities or the presence of an azeotype. Thus, a chemist may immediately identify any such viability issues and return to further experiments in the laboratory without waiting for analysis and suggestions from process engineers.

When the devices are determined by topology generator 216, flow controller 218 (see FIG. 7A and FIG. 7B) performs the function of developing process flows 266. Developing process flows 266 involves the development of material flows, energy flows, and waste and recycle flows. This is accomplished by working backwards from the desired amount of final product. Based upon the way the final reaction has been run in the laboratory, the amount of starting material for that reaction is determined. After reaching the beginning of the reaction pathway (i.e., the ultimate starting material) the system makes a second pass forward through all the reactions to determine what other products (e.g., waste) are also generated, and whether the predicted conditions are likely to be as expected.

Once process flows have been developed, system 200 retrieves production parameters via input handler 202 as described in association with FIG. 5A and FIG. 5B. Such parameters are provided to project data manager 206 and provided to topology evaluation controller 224 for performance of the function scaling process flows 268. The scaled topology is then provided to output handler 204 for the function displaying topology 270.

FIG. 9 shows a state diagram for evaluating process topology according to one embodiment of the system of the present invention. The evaluation of the topology begins with critique requested 280 through input handler 202 (see FIG. 7B) to topology evaluation controller 224. As previously discussed, topology evaluation controller 224 provides the scaled topology and critique request to critics manager 226. In addition, topology evaluation controller 24 determines the type of critic to be executed. Topology evaluation controller 24 will always execute basic evaluation 282. Basic evaluation 282 determines the material input requirements and material flows through the different equipment in the topology. This information is used by the specific types of critics.

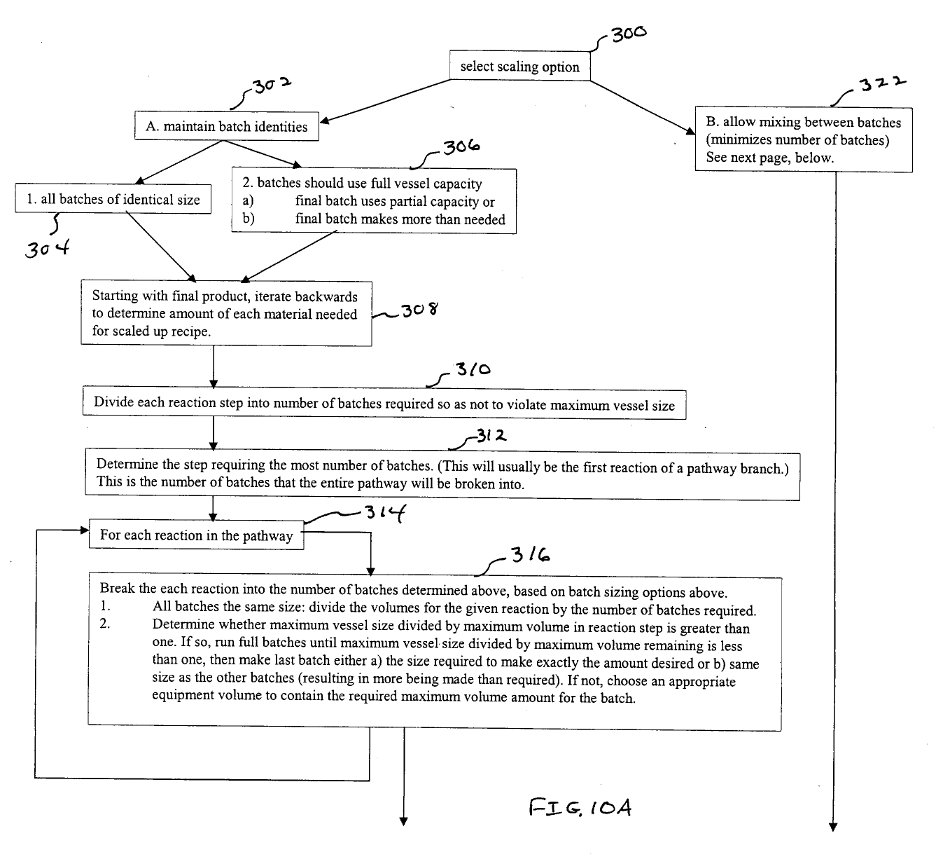

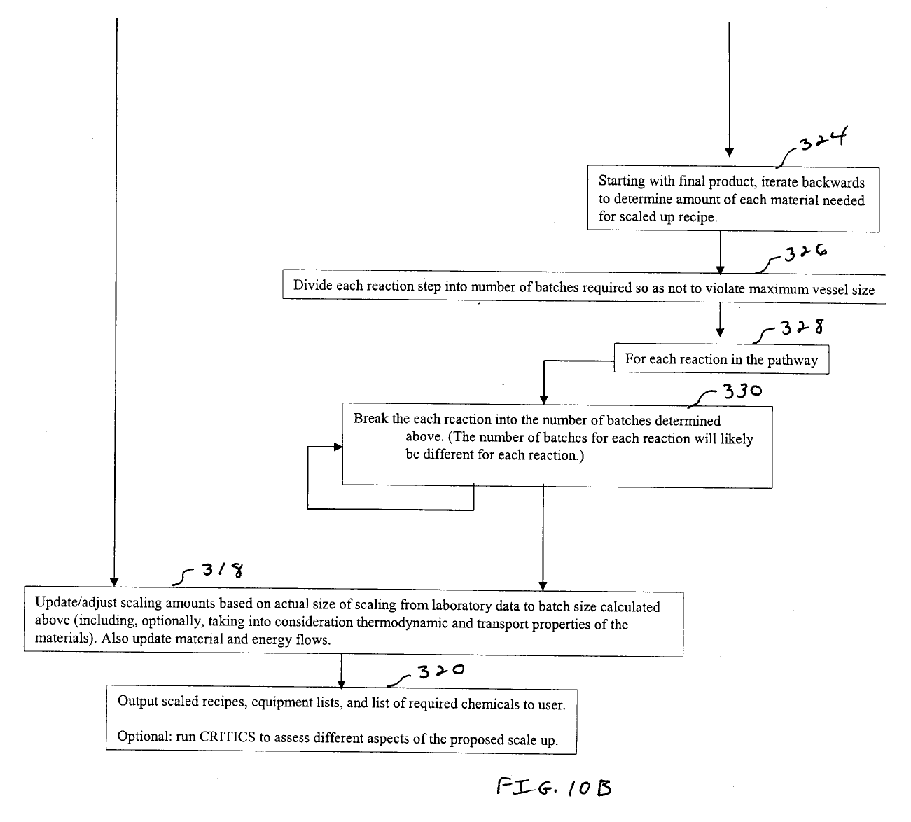

As shown in FIG. 10, three types of critics are performed in running critics 284. These three critics are running economic critic 286, running chemical critic 288, and running unit op critic 290. Running economic critic 286 determines process and material costs associate with the scaled topology. Running chemical critic 288 evaluates any potential environmental, safety, or hazard issues with the materials of the topology. The materials evaluated include the substances used in the recipe, whether an additive, by-product, or final chemical product. Running unit op critic 290 determines the feasibility of a unit operation, such as distillation, crystallization, etc. These critics are, as aforementioned, of the type disclosed in Miller et al.

It will be appreciated by those of skill in the art that the addition of critics to system 200 of the present invention is advantageous. Not only does system 200 automatically determine the equipment necessary and scale the equipment for a production and/or laboratory environment, critical analysis is performed to determine the issues that might arise from such a production model. While FIG. 9 shows three types of critics, other critics may be included in system 200. Such other critics may include, for example, regulatory and waste generation.

It will also be appreciated that the use of critics provides a research chemist with immediate feedback as to the viability of a particular topology. If viability is compromised in any manner as indicated by the critics, the chemist may move forward in a way that corrects the problem prior to spending significant time optimizing a process that cannot be effectively scaled to production.

Referring now to FIG. 10A and FIG. 10B, there is shown a flow chart of one embodiment of the steps used to scale the equipment according to the present invention. As previously discussed in connection with FIG. 5A and FIG. 5B, this embodiment of the system and method of the present invention provides several options for the scaling functionality. In all instances, as shown in FIG. 5A, the user enters the amount of end product chemical to be produced in production amount field 152 of basic production scaling window 150. The amount may be specified in volume, moles, or weight, for example. In all instances the user enters the maximum desired vessel capacity in maximum device capacity field 154 of basic production scaling window 150. The user may select the various options in advanced production scaling window 162, or use the default settings of basic production scaling window 150 which, in one embodiment, requires that the scaling be based on the maximum desired vessel capacity and that the final batch be of the same size (which may result in excess production beyond the amount of end product to be produced.

Returning now to FIG. 10A and FIG. 10B, after the user selects the scaling option in step 300, the scaling subsystem of the present invention proceeds either to step 302 or step 322. Step 322 is used when the user makes the proper selection on advanced production scaling window 162 (See FIG. 5B), while all other options selected are dealt with through step 302, indicating that mixing between batches is not to occur.

From step 302, the system then determines whether the user desires to keep all batches of identical size without regard to vessel capacity in step 304, or to use full vessel capacity and either allow for a partial final batch or make all batches identical in step 306. Based on the selection reflected in step 304 or step 306, the system then iterates backward in step 308. The interaction of step 308 begins with the final product and works backward to the starting materials. In this manner, the amount of each material required based on directly scaling up the amount used in the laboratory and assuming the entire pathway will scale linearly. The system may also iterate forward to determine what other materials (e.g., waste materials) may be made in each reaction step in the pathway and updates complete material flows.

In step 310, each material flow is broken down to ensure that any given reaction/separation sequence does not exceed the maximum vessel capacity entered by the user. For each distinct reaction, the system may then (if desired and sufficient information is available) recalculate the scaling to take into account nonlinearities in the scaling, and/or to incorporate additional experimental scale-up information. Such additional scale-up information may comprise, for example, selectivity, kinetics, heat transfer effects, etc.

In step 312, the system of the present invention then determines the reaction step requiring the most number of batches to be performed. Often, this step requiring the most batches is the first reaction of a pathway branch because some materials is usually lost to waste in later reactions in that pathway. The number of batches determined in step 312 is the number of batches that will be used for the entire pathway.

Steps 314 and 316 represent a function performed with regard to each reaction in a pathway. If all batches are to be the same size, the volumes for the given reaction are divided by the number of batches determined in step 312. If, on the other hand, all batches are not required to be the same size, at step 316 the maximum vessel size is divided by the maximum volume in the reaction step. If the result is greater than one, full batches are run until the maximum vessel size divided by the maximum volume remaining is less than one. When the result is less than one, then the last batch is either sized to make the batch exactly the amount desired (if the final batch can be a partial batch), or made the same size as the other batches resulting in more being generated then required. If, initially, the maximum vessel size divided by maximum volume in a reaction step is not greater than one, an appropriate equipment volume is selected to contain the required maximum volume amount for the batch.

Once step 316 is repeated for each pathway, if there are multiple pathways, steps 312, 314, and 316 are performed for each pathway. The system then, in either case, proceeds to step 318. In step 318, the system updates/adjusts the scaling amounts based on actual size of scaling from laboratory data to the above-calculated batch size. Optionally, system 318 may take into consideration thermodynamic and transport properties of the materials. The material and energy flows are likewise updated in step 318.

From step 318, the system may output a report or run critics in step 320. Such reports and critics have been previously described herein.

Returning to step 300 the system may handle scaling wherein mixing is permitted between batches. Generally, selection of such an option, acknowledged in step 322, minimizes the number of batches required.

Proceeding to step 324, starting with the amount of the final product, the system iterates backward to determine the amount of each material needed for the scaled up recipe. At step 326, each reaction step is divided into a number of batches requires so as to not violate the maximum vessel capacity. Step 328 shows, for each reaction of a pathway, that the system breaks each reaction of that pathway into the number of batches determined for that reaction in step 326. The number of batches for each reaction of the pathway are not required to be the same in this scaling method. Steps 328 and 330 are then repeated for each pathway of the recipe. Then, the scaling amounts are updated/adjusted in step 318, and reports may be generated or critics run in step 320.

In an alternate embodiment of the system and method of the present invention, the means for generating the topology may first involve scale-up of the recipe until the amount of scale-up and the maximum vessel size are known. At this point, the topology may be evaluated to determine if the initial equipment selection does not have embodiments suitable for the given scale. In another alternative, the equipment database is initially filtered so that only those devices that may be of appropriate size are allowed to be selected. In yet another embodiment, the topology creator is forced to use existing real equipment (as determined by querying a database, for example) versus using standard equipment types (also determined by querying a database, for example). The user could select the type of database to be used in generating the topology, and to edit the types and numbers of each type of equipment in such databases.

It will be appreciated by those of skill in the art that the provision of equipment types and sizes by the system of the present invention is very useful. A user, including a chemist, may determine whether the proposed topology is feasible in production. Such a determination is made based on laboratory data and is not dependent upon analysis by a process or design engineer.

It will also be appreciated by those of skill in the art that the system and method of the present invention has many benefits in determining chemical process design for manufacture from laboratory information. The user interface utilizes natural language in a free form familiar to chemists. This natural language is forgiving with regard to format, i.e., flexibility in the order of expressions is permitted, and is also accommodating with regard to errors, i.e., the error handler of the language handler is able to make alternate suggestions when an error is detected. Also, the user may enter superfluous text, such as prepositions, without giving rise to an error, for such superfluous information is ignored by the language handler. This user interface is also very efficient when compared to prior art systems, as it does not require a multiplicity of entries for a single labstep.

It will be further appreciated that the automatic generation of both the type and sizes of equipment required for the suggested topology is very useful. A user is able to quickly determine if unreasonable equipment (such as unusually large equipment) is required, or if the equipment costs exceed what may be viewed as reasonable costs. The user is also able to determine the number of batches required to produce a desired amount of the chemical products produced by the topology. Further, the user may simply scale the laboratory process for production to determine basic viability without the necessity of generating the topology required for such production. The scaling can be based on desired or predetermined amount, with such amount expressed in volume, moles, weight, etc.

In addition to the features related to the user interface and equipment used for manufacture, it will be appreciated by those of skill in the art that the system of the present invention includes other features and functions useful in moving a project from a laboratory to production. These features include the validation of the pathways that comprise the project, and the use of critics to determine viability and feasibility of the topology.

As used herein and in the claims, the term “process topology” means all data and information for a chemical process, including but not limited to process flow, engineering information and data, equipment selection, sizing, and connectivity, and conditions (such as pressure, temperature, mixing, stirring, etc.).

I claim:

1. A system, comprising:
means for developing process topology for at a least one chemical reaction, the at least one chemical reaction comprising a recipe; and
a language handler for entry of the recipe, the language handler accepting textual information in free form entered by a user of the system for representation of the recipe.

2. The system of claim 1, wherein the textual information is comprised of individual characters, and wherein the language handler comprises:
a lexer to form at least one word from individual characters of the textual information; and
a parser to form at least one sentence from the at least one words formed by the lexer.

3. The system of claim 1, further comprising:
an error checking subsystem to alert the user of the detection of textual information not recognizable by the language handler.

4. The system of claim 1, wherein the language handler further comprises:
means for stripping superfluous information from the textual information.

5. The system of claim 1, wherein the language handler is further capable of recognizing quantities, units, and commands.

6. The system of claim 1, wherein the means for developing process topology comprises:
means for identifying equipment necessary to execute the recipe.

7. The system of claim 6, wherein the means for developing process topology further comprises:
means for sizing the identified equipment.

8. The system of claim 7, wherein the equipment sizing means utilizes a pre-determined maximum size value.

9. The system of claim 7, wherein the equipment sizing means utilizes a predetermined end product amount for a chemical produced as a result of execution of the recipe.

10. A method for developing a process topology for at least one chemical reaction, the at least one chemical reaction comprising a recipe, the method comprising the steps of:
entering into a system textual information in free form, such textual information representative of the recipe; and
interpreting the textual information into one or more of the group consisting of quantity, units, and commands.

11. The method of claim 10, wherein the textual information comprises individual characters, and wherein the step of interpreting comprises the steps of:
forming at least one word from individual characters of the textual information; and
forming at least one sentence from the at least one words formed.

12. The method of claim 10, further comprising the step of:
establishing a database of recognizable characters and/or words; and
checking the textual information for compliance with the recognizable characters and/or words.

13. The method of claim 10, further comprising the step of:
stripping superfluous information from the entered textual information.

14. A system, comprising:
means for entry of at least one chemical reaction, the at least one chemical reaction comprising a recipe for synthesizing at least one chemical product; and
means for developing process topology for the at least one chemical product from the recipe, the process topology developing means comprising means for identifying equipment necessary to manufacture the at least one chemical product using the recipe.

15. The system of claim 14, wherein the process topology development means further comprises:
means for sizing the identified equipment based on predetermined amount(s) of the at least one chemical products to be manufactured.

16. The system of claim 15, further comprising:
means for entry of the predetermined amount(s) of the at least one chemical products to be manufactured.

17. The system of claim 15, wherein the means for sizing the identified equipment further comprises a means of comparing the identified equipment size(s) to a threshold size.

18. The system of claim 15, wherein the means for sizing the identified equipment further comprises a means for adjusting the size of any equipment that exceeds the threshold size.

19. The system of claim 15, wherein the means for sizing the identified equipment includes the ability to determine such sizing using at least one batch for manufacture of the predetermined amount(s) of the at least one chemical product.

20. The system of claim 14, wherein the means for entry comprises:
a language handler for entry of the recipe as textual information in free form.

21. The system of claim 20, wherein the language handler comprises:
a lexer to form at least one word from individual characters of the textual information;
and a parser to form at least one sentence from the at least one words formed by the lexer.

22. A method for developing a process topology for at least one chemical reaction, the at least one chemical reaction comprising a recipe for synthesizing at least one chemical product, the method comprising the steps of:
entering the recipe into a system; and
developing the process topology from the recipe, the development step including the step of identifying equipment necessary to manufacture the at least one chemical product.

23. The method of claim 22, wherein the development step further comprises the step of:
sizing the identified equipment based on predetermined amount(s) of the at least one chemical products to be manufactured.

24. The method of claim 23, wherein the step of sizing the identified equipment comprises the steps of:
comparing the size(s) of the identified equipment to a threshold size; and
adjusting the size(s) of the identified equipment that exceed the threshold size.

25. The method of claim 22, wherein the step of entering the recipe comprises the steps of:
entering textual information in free form, the textual information comprising individual characters;
forming at least one word from individual characters of the textual information; and
forming at least one sentence from the at least one words formed.

26. A system, comprising:
means for scaling a recipe for synthesizing at least one chemical product for production, the recipe comprising at least one laboratory process step, each of the at least one laboratory process steps representing a step in the process of synthesizing the at least one chemical product in a laboratory setting.

27. The system of claim 1, further comprising:
a language handler for entry of the recipe, the language handler accepting the free form entry of textual information of individual characters and comprising a lexer to format least one word form the individual characters and a parser to format least one sentence form the at least one word formed by the parser.

28. A method comprising the steps of:
scaling a recipe for synthesis of at least one chemical product for production, the recipe comprising at least one laboratory process step, each of the at least one laboratory process steps representing a step in the process of synthesizing the at least one chemical product in a laboratory setting.

29. The method of claim 28, further comprising, prior to the scaling step, the step of:
entering textual information comprising individual characters in free form, the textual information representative of the recipe.
